(19) United States
(12) Patent Application Publication
(10) Pub. No.: US 2006/0092831 A1
(43) Pub. Date: May 4, 2006

(54) Methods, systems, and computer program products for substitution of card-based telephony bearer channel switch modules in a manner that preserves stable calls

(75) Inventors: Thomas Hartnett, East Sandwich, MA (US); Paul B. Richards, Barnstable, MA (US)

Correspondence Address: JENKINS, WILSON & TAYLOR, P. A., 3100 TOWER BLVD, SUITE 1200, DURHAM, NC, 27707, US

(73) Assignee: Tekelec

(21) Appl. No.: 11/263,649

(22) Filed: Oct. 31, 2005

Related U.S. Application Data
(60) Provisional application No. 60/623,974, filed on Nov. 1, 2004.

(51) Int. Cl. H04J 3/14

(52) U.S. Cl. 370/217

(57) ABSTRACT

Methods, systems, and computer program products for substitution of card-based telephony bearer channel switch modules in a manner that preserves stable calls are disclosed. According to one method, a first card-based telephony bearer channel switch module of a plurality of card-based telephony bearer channel switch modules is designated as a substitution switch module. A second card-based telephony bearer channel switch module of the plurality of card-based telephony bearer channel switch module is designated as an active switch module. Stable calls are established using the second card-based telephony bearer channel switch module. Configuration information for the second card-based telephony bearer channel switch module is communicated to the first card-based telephony bearer channel switch module. Call state information for calls involving the second card-based telephony bearer channel switch module is obtained from the first card-based telephony bearer channel switch modules. In response to detecting failure of the active switch module, the first card-based telephony bearer channel switch module is switched, using the configuration and call state information, to operate as the second card-based telephony bearer channel switch module in a manner that maintains the stable calls.

### RELATED APPLICATIONS

This application claims the benefit of U.S. Provisional Patent Application Ser. No. 60/623,974, filed Nov. 1, 2004; the disclosure of which is incorporated herein by reference in its entirety.

### TECHNICAL FIELD

The subject matter described herein relates to methods, systems, and computer program products for providing redundancy in telecommunications switching systems. More particularly, the subject matter described herein relates to methods, systems, and computer program products for substitution of card-based telephony bearer channel switch modules in a manner that preserves stable calls.

### BACKGROUND ART

In telecommunications networks, telecommunications switches are devices that switch media or bearer channels for calls. Because such switches are essential to connecting and maintaining connections between end users, it is desirable to provide high availability and high reliability switching systems. One conventional method for providing reliability is 1:1 redundancy where each hardware component of a switch has a redundant component. However, providing a redundant component for each active component greatly increases the cost of a telecommunication switch.

An alternate approach to providing redundancy is n:1 redundancy where n telecommunications switching components function as active components and one component functions as a standby component capable of being substituted for the active components. Providing n:1 redundancy decreases the cost over 1:1 redundancy at the expense of reliability if more than one component fails.

Although n:1 redundancy provides a less costly solution than 1:1 redundancy, one problem with at least some conventional n:1 redundancy schemes is that when a redundant component is substituted for an active component, the software of the redundant component must be booted from an initial state. Booting the software of the redundant component from an initial state can cause existing calls in progress to be dropped. Dropping calls in progress is undesirable in telecommunications switches and can result in loss of subscribers and/or regulatory penalties.

Accordingly, in light of these difficulties associated with conventional 1:1 and n:1 telecommunications switch redundancy schemes, there exists a need for improved methods, systems, and computer program products for substitution of card-based telephony bearer channel switch modules in a manner that preserves stable calls.

### SUMMARY

According to one aspect, the subject matter described herein includes a method for substitution of card-based telephony bearer channel switch modules in a manner that preserves stable calls. The method includes designating a first card-based telephony bearer channel switch module of a plurality of telephony bearer channel switch modules as a substitution switch module. A second card-based telephony bearer channel switch module of the plurality of card-based telephony bearer channel switch modules is designated as an active switch module. Stable calls are established using the second card-based telephony bearer channel switch module. At the first card-based telephony bearer channel switch module, configuration information regarding the second card-based telephony bearer channel switch module is obtained. At the first card-based telephony bearer channel switch module module, call state information for calls established using the second card-based telephony bearer channel switch module is obtained. Failure of the second card-based telephony bearer channel switch module is detected. In response to detecting the failure, the first card-based telephony bearer channel switch module is switched to operate as the second card-based bearer channel switch module in a manner that maintains the stable calls.

As used herein, the term “card-based telephony bearer channel switch module” refers to a card or circuit board that includes hardware and software for connecting telephone bearer channels. An example of a card-based telephony bearer channel switch module is described in commonly assigned U.S. Pat. No. 6,381,239, the disclosure of which is incorporated herein by reference in its entirety. In one exemplary implementation, a card-based telephony bearer channel switch module comprises a switch on a card that includes all of the hardware and software needed to set up and maintain telephone bearer channels for a call half. Further examples of card-based telephony bearer channel switch modules will be described in detail below.

As used herein, the terms “stable calls” and “calls in progress” are intended to refer to calls in which call setup signaling has been completed and in which the bearer channels between the call endpoints are connected.

The subject matter described herein for substitution of card-based telephony bearer channel switch modules in a manner that preserves stable calls may be implemented in hardware, software, firmware, or any combination thereof. In one implementation, the subject matter described herein can be implemented as a computer program product comprising computer executable instructions embodied in a computer readable medium. Exemplary computer readable media suitable for implementing the subject matter described herein include chip memory devices, disk memory devices, programmable logic devices, application specific integrated circuits, and downloadable electrical signals. In addition, a computer program product that implements the subject matter described herein may be located on the single device or computing platform or may be distributed across multiple devices for computing platforms.

### BRIEF DESCRIPTION OF THE DRAWINGS

Preferred embodiments of the subject matter described herein may now be explained with reference to the accompanying drawings of which:

FIG. 1 is a flow chart illustrating an exemplary process for substitution of card-based telephony bearer channel switch modules in a manner that preserves stable calls according to an embodiment of the subject matter described herein;

FIG. 2 is a block diagram of a system for substitution of card-based telephony bearer channel switch modules in a manner that preserves stable calls illustrating transfer of configuration information between the card-based telephony switch modules in a substitution group prior to card failure according to an embodiment of the subject matter described herein;

FIG. 3 is a block diagram of a system for substitution of card-based telephony bearer channel switch modules in a manner that preserves stable calls illustrating transfer of call control blocks between a substitution card and an active card prior to failure of the active card according to an embodiment of the subject matter described herein;

FIG. 4 is a block diagram of a system for substitution of card-based telephony bearer channel switch modules in a manner that preserves stable calls illustrating switching between the active card an the substitution card after failure of the active card according to an embodiment of the subject matter described herein;

FIG. 5 is a block diagram of a system for substitution of card-based telephony bearer channel switch modules in a manner that preserves stable calls illustrating the collection of call control blocks and the resumption of call processing by the new active card according to an embodiment of the subject matter described herein;

FIG. 6 is a block diagram illustrating exemplary hardware components of a card-based telephony bearer channel switch module according to an embodiment of the subject matter described herein;

FIG. 7 is a block diagram illustrating an exemplary T−2 phase of a card substitution process from the perspective of trunk management software according to an embodiment of the subject matter described herein;

FIG. 8 is a block diagram illustrating an exemplary data structure used by a substitution card to store configuration and trunk state information according to an embodiment of the subject matter described herein;

FIG. 9 is a block diagram illustrating an exemplary T−1 phase of a card substitution process from the perspective of trunk management software according to an embodiment of the subject matter described herein;

FIG. 10 is a block diagram illustrating an exemplary T+1 phase of a card substitution process from the perspective of trunk management software according to an embodiment of the subject matter described herein;

FIG. 11 is a block diagram illustrating an exemplary T+2 phase of a card substitution process from the perspective of trunk management software according to an embodiment of the subject matter described herein;

FIG. 12 is a message flow diagram illustrating exemplary audit messages exchanged between application-level call control software and trunk management software in obtaining trunk status updates according to an embodiment of the subject matter described herein;

FIG. 13 is a block diagram illustrating an exemplary card switch back operation from the perspective of trunk management software according to an embodiment of the subject matter described herein;

FIG. 14 is a block diagram illustrating exemplary messaging between an active card and a substitution card using DSP messaging over a TDM midplane according to an embodiment of the subject matter described herein;

FIG. 15 is a block diagram illustrating exemplary exchange of TDM event information between an active card and a substitution card using a TDM bus and different TDM channels according to an embodiment of the subject matter described herein;

FIG. 16 is a block diagram illustrating an exemplary allocation of TDM signaling channels among cards according to an embodiment of the subject matter described herein;

FIGS. 17A-17C are block diagrams illustrating exemplary message formats for communicating state information to a substitution card using a DSP and TDM channels according to an embodiment of the subject matter described herein;

FIG. 18 is a block diagram illustrating an exemplary T−2 phase of a card substitution process from the perspective of analog subscriber line management software according to an embodiment of the subject matter described herein;

FIG. 19 is a block diagram illustrating an exemplary T−1 phase of a card substitution process from the perspective of analog subscriber line management software according to an embodiment of the subject matter described herein;

FIG. 20 is a block diagram illustrating an exemplary T+1 phase of a card substitution process from the perspective of analog subscriber line management software according to an embodiment of the subject matter described herein;

FIG. 21 is a block diagram illustrating an exemplary T+2 phase of a card substitution process from the perspective of analog subscriber line management software according to an embodiment of the subject matter described herein;

FIG. 22 is a block diagram illustrating exemplary steps of a switch back from a substitution card to and active card from the perspective of analog subscriber line management software according to an embodiment of the subject matter described herein;

FIG. 23 is a block diagram illustrating exemplary substitution, system manager, and system monitoring processes according to an embodiment of the subject matter described herein; and

FIG. 24 is a diagram illustrating messages that may be exchanged between processes and cards in performing card substitution according to an embodiment of the subject matter described herein.

### DETAILED DESCRIPTION

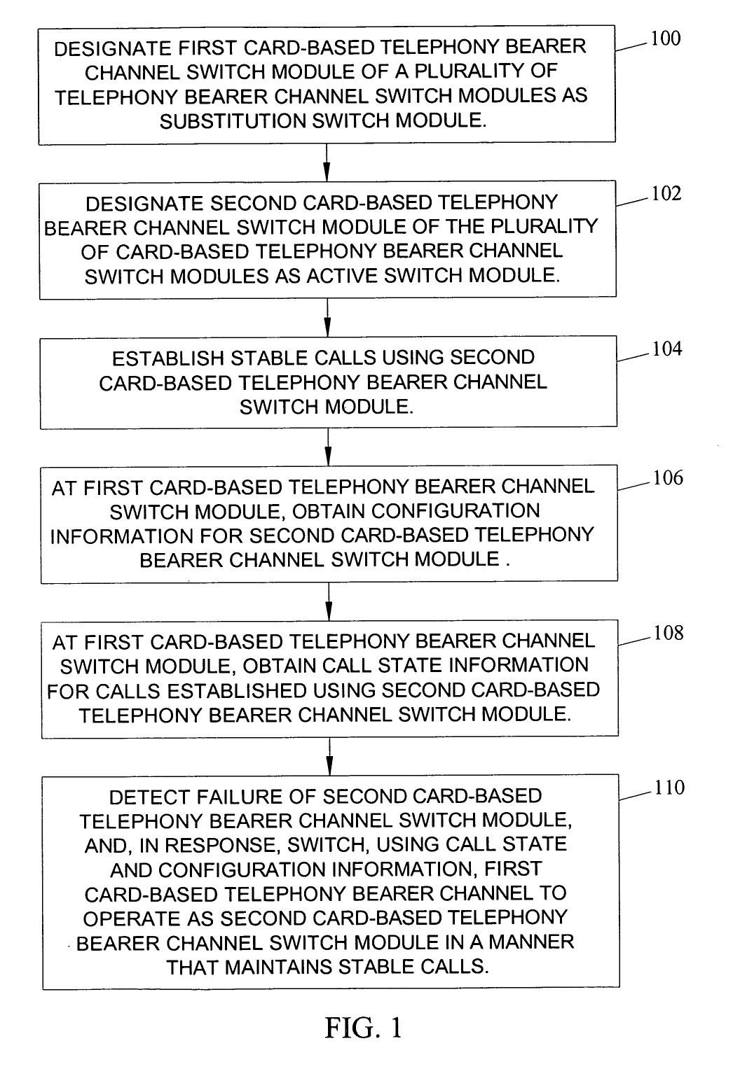

According to one aspect, the subject matter described herein includes a method for substitution of card-based telephony bearer channel switch modules in a manner that preserves stable calls. FIG. 1 is a flow chart illustrating an exemplary process for substitution of card-based telephony bearer channel switch modules in a manner that preserves stable calls according to an embodiment of the subject matter described herein. Referring to FIG. 1, in step 100, a first card-based telephony bearer channel switch module of a plurality of telephony bearer channel switch modules is designated as a substitution switch module. In step 102, a second card-based telephony bearer channel switch module of the plurality of card-based telephony bearer channel switch modules is designated as the active switch module. Step 102 can be repeated for the number, “n” in the n:1 substitution group. In step 104, stable calls are established using any of the second card-based telephony bearer channel switch modules. In one exemplary implementation, internally, each active switch module may implement a half call model where each module maintains call state for a call half and sets up a bidirectional TDM connection with one endpoint of a call. Externally, the stable calls may be established using in-band signaling, such as CAS signaling, or using out-of-band signaling, such as SS7 or ISDN signaling.

In step 106, configuration information for the second card-based telephony bearer channel switch module is obtained at the first card-based telephony bearer channel switch module. Examples of such configuration information will be described in detail below. In step 108, call state information for calls established using the second card-based telephony bearer channel switch module is obtained at the first card-based telephony bearer channel switch module. In step 110, in response to detecting failure of the second card-based telephony bearer channel switch module, the first card-based telephony bearer channel switch module is switched, using the configuration and call state information, to operate as the second card-based telephony bearer channel switch module in a manner that maintains the stable calls. In order to maintain the stable calls, the switchover must occur fast enough so that the far end of each stable call does not think that the connection has been terminated. In one exemplary implementation, this switchover may occur on the order of milliseconds or tens of milliseconds. The time in which the card substitution must be performed to avoid dropping calls may depend on alarm timers set by the network operator associated with the far end of each call.

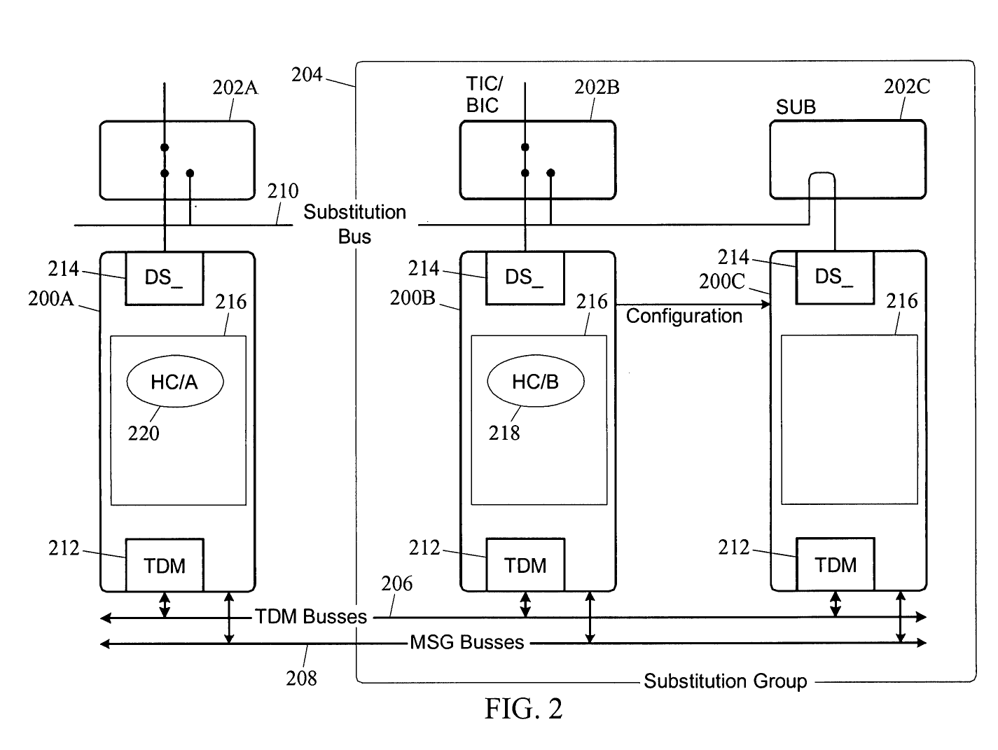

FIG. 2 is a block diagram of a system for substitution of card-based telephony bearer channel switch modules in a manner that preserves stable calls. Referring to FIG. 2, a plurality of card-based telephony bearer channel switch modules 200A-200C is shown. Each card-based telephony bearer channel switch module 200A-200C receives PSTN signals via an input/output (I/O) card 202A-202C. In the illustrated example, cards 200B and 200C form a substitution group 204 in which card 200B functions as the active card and card 200C functions as the substitution card.

FIG. 2 shows a single active card within a substitution group 204. Actual realizations allow for many instances of 202B-type cards within a system. The number of these 202B-type cards may be limited only by the physical geometry of substitution bus 210.

In the system illustrated in FIG. 2, cards 200A-200C are connected to each other via time division multiplexed (TDM) buses 206, message buses 208, and a substitution bus 210. TDM buses 206 carry voice channels between the cards. Message buses 206 carry control information between the cards. Substitution bus 210 is used to carry signals to the substitution card when the active card fails. For example, when active card 200B fails, the relays in the I/O card associated with the active card are switched so that the PSTN signals to and from the failed active card are sent over the substitution bus. The relays on the I/O card associated with substitution card 200C are switched so that the PSTN signals from the failed active card are communicated to substitution card 200C.

In the illustrated example, each bearer channel telephony switch module includes resources for maintaining half calls according to a half call model. These resources include TDM drivers 212, framers 214, and memory 216. TDM drivers 212 place data on and extract data from TDM channels for call halves maintained by each card. TDM drivers 212 may also send and receive messages between cards relating to card substitution. Framers 214 frame incoming and outgoing signals. For example, framers 214 may be implemented using DS-N framers where N is an integer of at least zero. Memory 216 stores call state information for call halves. In the illustrated example, memory 216 of active card 200B stores half call B state information 218 for a given call. Memory 216 of card 200A, which is not a member of the substitution group, stores half call A state information 220, which corresponds to the other half of the call maintained by card 200B.

In the example illustrated in FIG. 2, a first stage of an exemplary card substitution process, referred to herein as the T−2 stage, is illustrated. The T−2 stage is a pre-failure stage where it is assumed that cards 200A-200C have been initialized. In order for substitution card 200C to be able to take over the operation of active card 200B without dropping stable calls, substitution card 200C must be provisioned with information that allows card 200C to maintain the stable calls involving card 200B and all other active cards in the substitution group. One piece of information that is transferred in the example illustrated in FIG. 2 is information regarding the configuration of framer 214 on active card 200B. The framing information may include the framing and signaling formats used by framer 214 of card 200B. This framing information is cached by substitution card 200C. The framing information may be transmitted over message bus 208. The data that is transmitted is derived from the TMS DCB 700.

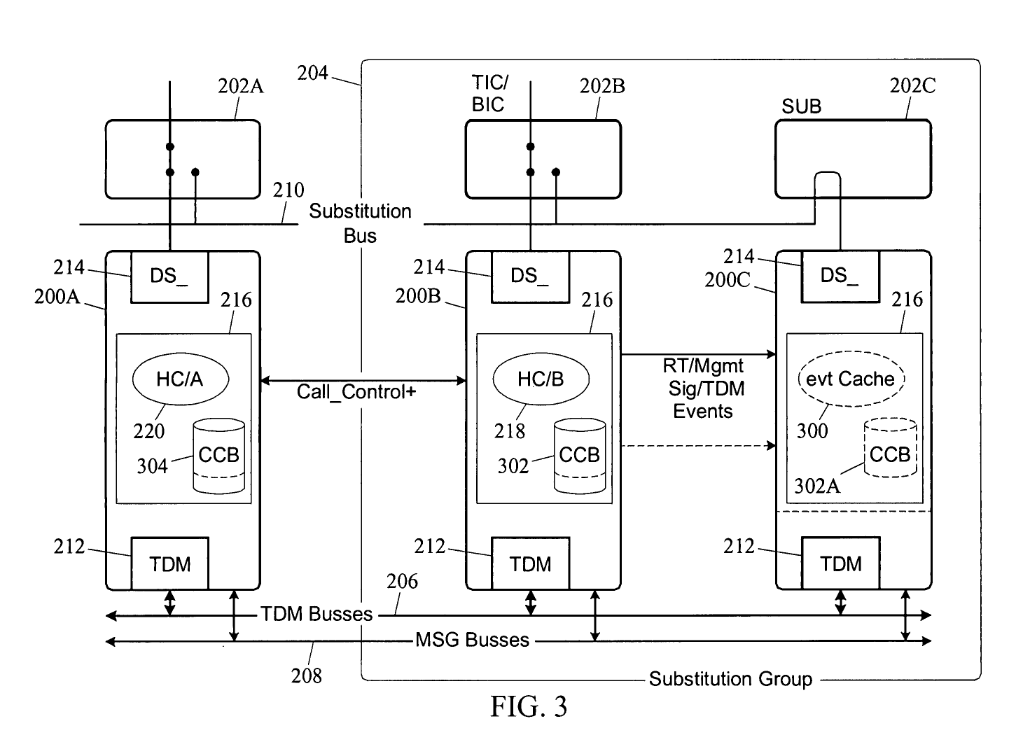

FIG. 3 illustrates a second stage, referred to herein as the T−1 stage, of an exemplary card substitution process according to an embodiment of the subject matter described herein. In the T−1 stage, it is assumed that the active card configuration information has been transferred to the substitution card. In this example, the events illustrated and described with respect to FIG. 3 are assumed to occur after the events illustrated in FIG. 2. In FIG. 3, active card 200B transfers signaling and TDM events to substitution card 200C. The signaling events include the last signaling state for a call, which is based on the last message received for a call. The TDM events may include information about how to connect the TDM channels for the call. Substitution card 200C stores the signaling and TDM event information in event cache 300.

Active card 200B also communicates call control blocks 302 to substitution card 200C. The call control blocks include the necessary and sufficient amount of state information for maintaining a call. Substitution card 200C stores the call control blocks 302A for the active call in memory 216. The signaling events and the call control blocks may be transmitted between active card 200B and substitution card 200C via message buses 208 or via the subway TDM channels 206.

Substitution card 200B may monitor changes in call control blocks 302 and communicate those changes to substitution card 200C. It should also be noted that card 200A also has call control blocks 302 which are not communicated to substitution card 200C because card 200A is not a member of the substitution group. The steps of communicating the signaling and TDM event information and the call control blocks to the substitution card are preferably performed by each card that is a member of the substitution group. For example, in an n+1 redundancy scheme, where n equals the number of active cards corresponding to a single substitution card, each of the n cards may send its call control blocks and signaling and TDM information to the substitution card.

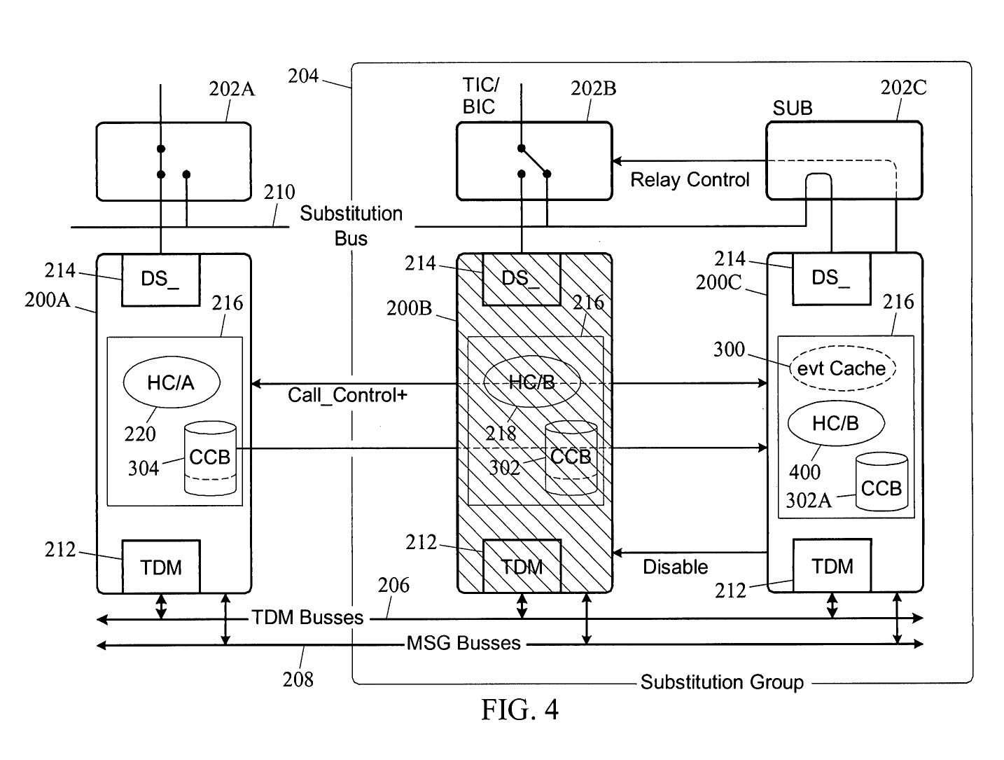

FIG. 4 illustrates a third stage, referred to herein as the T+1 stage, in an exemplary card substitution process according to an embodiment of the subject matter described herein. In the T+1 stage, it is assumed that active card 200B has failed and that substitution card 200C is beginning the process of taking over the operations of active card 200B. Referring to FIG. 4, active card 200B is shaded to indicate failure. Before switching the relays to connect substitution card 200C to the PSTN, framers 214 of substitution card 200C may be configured using the configuration information received from active card 200B as illustrated in FIG. 2. Once the framers have been configured, TDM channels for stable calls on substitution card must be configured. There are two options for configuring the TDM channels on the substitution card. In one option, the substitution card may use the same TDM channels that were being used by the active card for stable calls. An advantage of this approach is that TDM drivers on cards that had calls in progress with the active card do not need to be notified of the switchover. A disadvantage of this approach is that the now failing active card may still be using these channels, depending on the nature of the failure. A second option is for substitution card 200C to renegotiate TDM channels for active calls with the other cards that were communicating with active card 200B. Such renegotiation requires that messages be sent to each of the cards that maintained a call half for a call with active card 200B indicating the new TDM channels for the call. The renegotiation may be performed using in-band signaling sent over the TDM bus between the cards. For example, substitution card 200C may send a message to the active card associated with the other half of a call for which one half is maintained by active card 200B indicating new TDM transmit and receive channels for the call. The receiving card may either accept the new channels by responding with an acknowledgement message or select new transmit and/or receive channels. The substitution card may accept or reject the channels requested by the active card. The process may be repeated until the cards agree on transmit and receive timeslots. The renegotiation process may be performed for each stable call.

Once the framers and TDM channels have been configured, I/O module 202C of substitution card 200C sends a relay control signal to I/O card 202B of substitution card 200B to switch the relays to connect the PSTN to substitution card 200C via I/O card 202C.

Substitution card 200C may send a disable signal to active card 200B. The disable signal instructs active card 200B to shut down. However, depending on the nature of the failure, the signal may be ignored. Substitution card 200C may also send messages to all cards in the system, and the other cards that had calls in progress with active card 200B will be informed that substitution card 200C has taken over the operation of active card 200B. These messages may be sent over message bus 208.

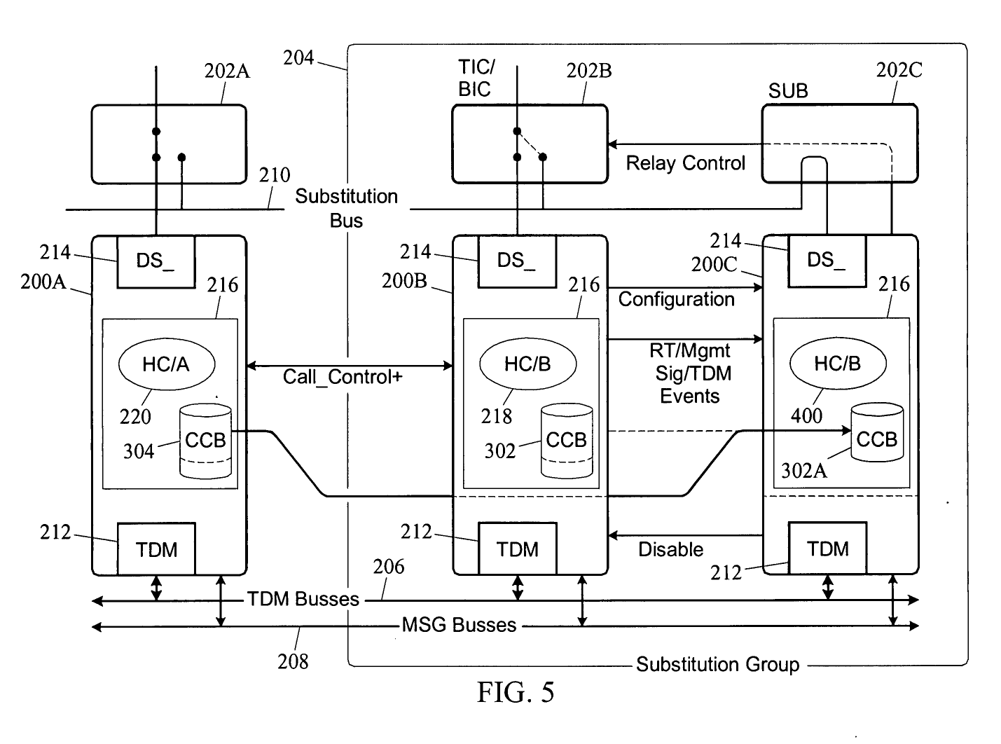

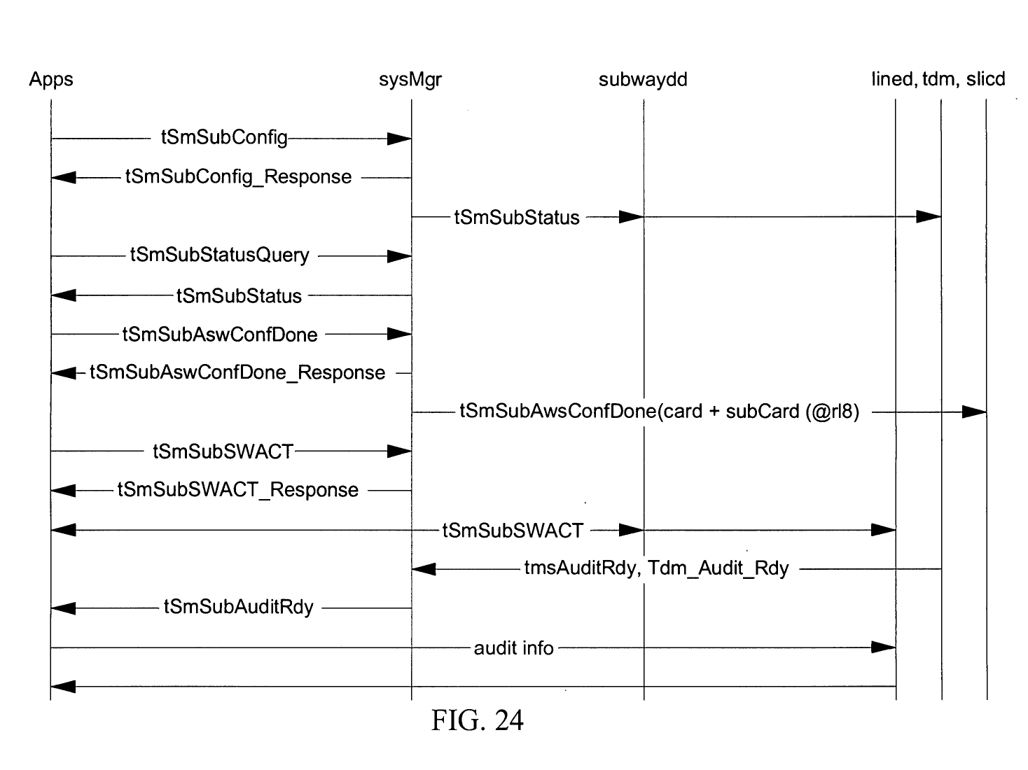

FIG. 5 is a block diagram that combines all of the events illustrated in FIGS. 24. That is, FIG. 5 illustrates the transfer of configuration information, management information, signaling and TDM events, and call control blocks from the active card to the substitution card. It should be noted that the normal call control information that is exchanged between call halves for calls in progress may not be sufficient to enable the substitution card to take over calls in progress. An additional piece of information that may be required to be communicated to the substitution card is the originating and destination timeslots used for a call. This information is illustrated as “call control +” in FIG. 5. FIG. 5 also illustrates failure of the substitution card, switching of the active and substitution card relays, and disabling of the substitution card.

One refinement of an exemplary card substitution process according to an embodiment of the subject matter described herein relates to the transfer of signaling and TDM events between cards once a failure has been detected. When a card fails, message bus 208 may become overloaded with unanswered messages and error messages. As a result, signaling events and other information that need to be transmitted between the substitution card and the active cards that maintained call halves with the failed active card may be too slow to maintain active calls. In order to alleviate this problem, the subject matter described herein may use TDM buses 206 to transfer such messages both before and after an active card fails. In one implementation, each card may be allocated one or more TDM timeslots on which that card can transmit control messages. On a 64 kbps TDM bus, where each card is allocated a single time slot, each card may transmit 8 bytes per millisecond. Any number of cards can listen to a card's transmission. In one implementation, the substitution card may listen to messages transmitted by cards in its substitution group. 8 bytes per millisecond is deemed to be sufficient for short control messages relating to signaling and TDM events.

Call control information may also be sent over the TDM bus, to avoid delays on the message buses. Because the TDM buses are non-blocking, messages are guaranteed to be received within a time period that is based on the size of the message, the number of TDM channels used to transfer control information, and the speed of the TDM bus.

In order to further increase the reliability of substitution messaging, a DSP, rather than a microprocessor, may be used to send and receive messages relating to card substitution between cards. In one exemplary implementation, DSPs used to play audio on the TDM channels may be used to transmit the control and call state information over the TDM channels. According to one aspect of the subject matter described herein, the subject matter described herein, DSPs that were traditionally used to play tones and announcements are used effectively as hi-level data link controllers (HDLCs) to send the signaling and TDM events over the TDM buses. This non-traditional use of audio DSPs is believed to be a further advantage of the subject matter described herein. For example, the DSPs are able to provide intercard, low latency communication even when the controlling processor of one or more of the cards has failed or is overloaded.

In addition to using the DSPs to transmit the control and call state information to the substitution card, it may also be desirable to provide a backup, low latency communication mechanism between cards. In one implementation, HDLC controllers (not shown in FIG. 5) may be used to implement the backup communications channel. The HDLC channels may be used to transfer the control messages mentioned above between cards when all of the TDM timeslots between the cards are being used for calls. An exemplary card architecture that includes HDLC controllers will be described in detail below.

As stated above, two options for TDM channel allocation when a substitution card takes over the operation of a failed active card are to have the substitution card negotiate new TDM timeslots for calls in progress with the former active card or to have the substitution card use the same TDM channels used by the failed active card. In an implementation in which the same TDM channels are used, a further refinement of the subject matter described herein may included testing the TDM channels to determine whether the failed active card is locked onto the channels rendering them unusable for maintaining the stable calls. In one implementation, substitution card may send a predetermined bit pattern out on each TDM channel desired to be used after substitution for the active calls. If no other card is transmitting on that channel, the substitution card should receive the same bit pattern that was transmitted. If the failed active card is locked on one of the channels, a different bit pattern may be received, and it may not be desirable to use that channel. Thus, by transmitting bit patterns on TDM channels, the substitution card can identify open TDM channels that can be used for stable calls. However, testing each channel may require multiple bits or even bytes of information to be transmitted on each channel. Testing each of multiple channels with a multi-byte pattern may be time consuming. Thus, as described above, it may be desirable to simply renegotiate the channels with the other cards that were formerly communicating with the active card.

Another refinement of a substitution process according to an embodiment of the subject matter described herein may be to implement a priority messaging scheme for messages transmitted over the message bus. In prior implementations of the system illustrated in FIGS. 2-5, messages transmitted over the message bus were all of the same priority. In an alternate implementation, messages used to carry configuration, call control information, or other information relating to the substitution process may be given a higher priority than normal call control messages transmitted between cards. In order to implement such a priority scheme, messages may include a priority field that includes one or more bits indicative of the priority of the message. The processor on each card that processes messages from the message bus may process messages of higher priority before processing messages of lower priority.

In a further refinement of the subject matter described herein, each card-based telephony bearer channel switch module may either maintain a copy of call state information for calls using each module in nonvolatile memory and/or stream that information to another card and use that state information to reestablish calls in the event of a software failure and reboot. A software failure and reboot may not require switching of relays as with the card substitution example described above. For software failures, stable calls can be reestablished if state information for the calls is preserved. In the case where a card transmits its state information to another card, it is assumed that this information is more reliable than locally stored information after a software failure. Accordingly, the card may reboot, request the state information from the neighbor card, and attempt to reestablish calls using the state information received from its neighbor card. If remote state information is not available, the card may reboot and attempt to reestablish calls using its local copy of the call state information. This redundancy mechanism for reestablishing calls in the event of a software failure may be used in systems without a substitution card or in systems in which the substitution card is currently being used as an active card.

In a further refinement of the subject matter described herein, the system illustrated in FIGS. 2-5 may be auto-revertive. In one exemplary implementation, after a substitution the card takes over the operation of an active card, and the active card reboots, the substitution card may communicate configuration, event, and call state information to the active card in the manner described above with regard to FIGS. 2-5. In response to receiving the call state information, the rebooted active card may send a message to the substitution card instructing the substitution card that it is now taking over stable calls. In response, the substitution card may begin operating in substitution mode, as described above.

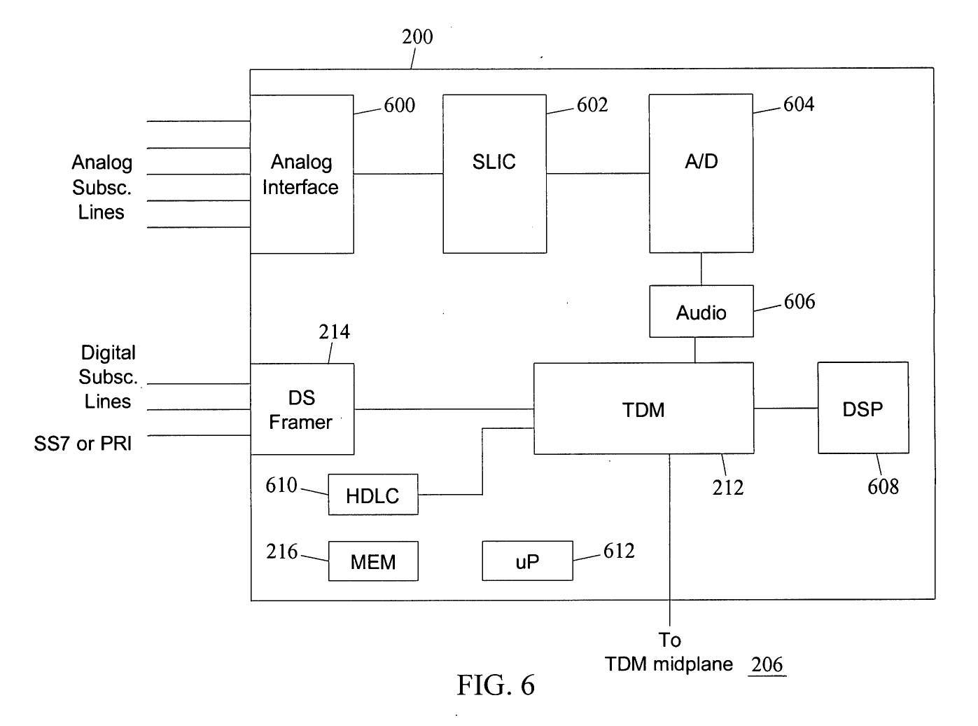

FIG. 6 is a block diagram illustrating exemplary hardware components of a card-based telephony bearer channel switch module according to an embodiment of the subject matter described herein. In the illustrated example, card-based telephony bearer channel switch module 200 includes an analog interface 600 for interfacing with analog subscriber lines and a digital interface or framer 214 for interfacing with digital subscriber lines. A TDM driver 212 interfaces with TDM midplane bus 206. On the analog side, a subscriber line interface controller (SLIC) 602 terminates analog subscriber lines. An analog-to-digital (A/D) converter 604, also known as a CODEC (for coder-decoder), converts incoming signals to digital format and converts outgoing signals to analog format. An audio DSP 606 performs functions for analog lines. A second DSP 608 performs similar functions for digital subscriber lines. In addition, DSP 608 may be used to transmit signals relating to substitution over TDM midplane 206 as described above.

An HDLC controller 610 performs HDLC functions, such as establishing point-to-point datalink layer connections between cards. In addition, as described above, HDLC controller 610 may provide a backup mechanism for transferring call state and configuration information between active cards and a substitution card. The overall operation of card-based telephony bearer channel switch module is controlled by a microprocessor 612.

Details of switching between active and substitution cards from the perspective of processes executing on the substitution card will now be described. In Section I, actions performed by trunk management software resident on the cards in performing substitution will be described. In section 11, actions performed in transmitting messages between cards using DSP messaging over the TDM bus will be described. In section III, actions performed by the TDM subsystem in performing card substitution will be described. In section IV, actions performed by analog subscriber line interface software in performing card substitution will be described. In Section V, actions performed by system manager, system monitor, and substitution processes in performing card substitution will be described.

I. Trunk Management Software Operations for Card Substitution

According to one exemplary implementation of the subject matter described herein, each card may include trunk management software (TMS) for managing trunks maintained by each card. The trunk management software may be a collection of one or more processes resident on each card 200 that are responsible for robbed-bit signaling, alarm monitoring and reporting, and maintenance tasks, which includes performance monitoring, and facility data link management for the DS1 and/or DS3 facilities of each card. This section describes the components and actions required to support card substitution, with regard to the TMS and software that interfaces with it.

This section may break up the actions required into the following phases:
T−2—this phase is early on in the card substitution support, prior to any substitution event and is principally responsible for synchronizing configuration information between the active cards and the substitution card.
T−1 and Holding—this phase is prior to any substitution event and includes actions that must be performed to ensure the substitution card is prepared to handle a substitution event. This is the phase that the vast majority of time is spent.
Card Failure—this is the substitution event (intentional or unintentional)
T+1—this is the phase that occurs immediately after the substitution event. The actions performed during this phase may be performed as expediently as possible to ensure that the card switchover occurs without the remote end detecting a problem.
T+2—this is the phase after a substitution event that does not require immediate action and simply provides for continued use of the substitution card that has taken over for the failed card.

This organization is used to stay consistent with FIGS. 2-5 above. In addition to these phases, this section may describe the actions required to switch back the substitution card from active to standby.

1. T−2 Phase

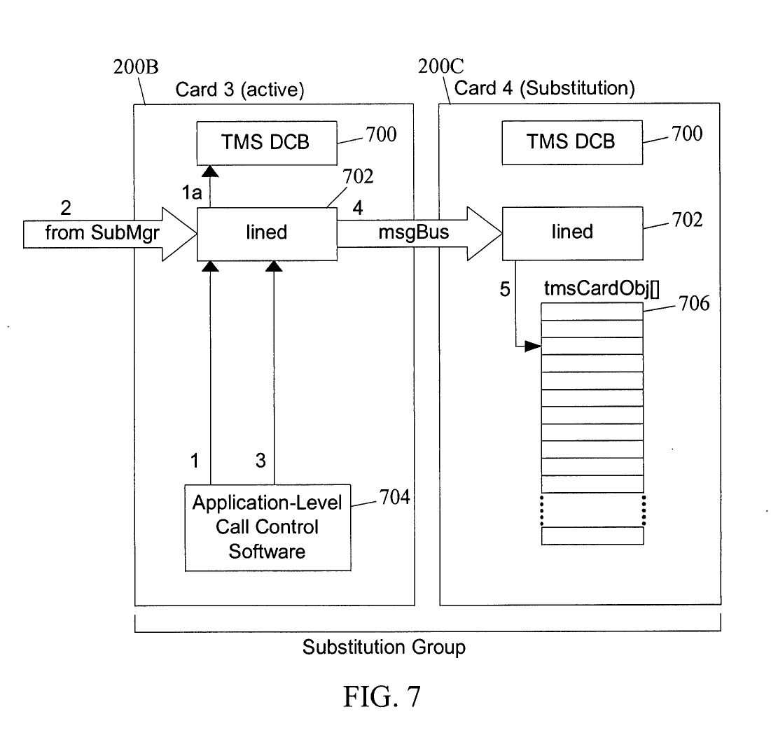

FIG. 7 illustrates exemplary steps that may be performed by the TMS software during the T−2 phase of an exemplary card substitution process according to an embodiment of the subject matter described herein. In FIG. 7, active card 200B and substitution card 200C are shown. Each card includes a trunk management software device control block (TMS DCB) 700 that stores call state information that allows drivers to perform trunk management and signaling. A line daemon (lined) process 702 processes events from application-level call control software 704 and controls drivers to perform corresponding actions. Application level call control software 704 is the application level software on each card that handles call control functions, such as channel associated signaling (CAS). tmsCardObj [symbol] 706 is a subset of the trunk management information from TMS DCB 700 of active card 200B that is collected from active card 200B and stored on substitution card 200C. The information stored in tmsCardObj [symbol] 706 includes trunk state information that allows substitution card 200C to take over operation for active card 200B in response to failure of active card 200B in a manner that preserves stable calls. The steps described below for the T−2 phase correspond to the numbered arrows in FIG. 7.

Step 1:

In step 1, application-level call control software 704 sends its configuration information to lined process 702 of active card 200B. This information includes signaling (type of signaling model used), alarm (transmit alarm state), and how to interface back to application-level call control software 704 (feedback of receive signaling and receive alarm state). The information is sent when the application-level call control software finite state machine (FSM) is initialized. Additional information is sent when a “restore card” is performed.

Step 1a:

In step 1a, lined process 702 of active card 200B may, while receiving the configuration information from application-level control software 704, update its DCB (Device Control Block) 700.

Step 2:

In step 2, a substitution process (not shown in FIG. 7) possesses the information regarding who is the substitution card for each active card. The substitution process sends that information to each active card that participates in the substitution group. In one exemplary implementation, the substitution process is a process that can reside on any card. The substitution process is provisioned with the identity of each substitution card and the members of each substitution group. The following function call may be implemented by the substitution process to communicate the substitution group information to the cards in the system:
Send(cardVirtualPid, tSmSubStatus, 7, cardNum, subCard, subStatus, minCard, maxCard, aswConfDoneFlag, auditRdyFlag);
// cardNum is my card address
// subCard is the slot number of my substitution card
// subStatus (of my card) is ACTIVE, STANDBY, or UNAVAILABLE
// minCard and maxCard are the min and max slot numbers of cards in the subgrp
   Step 3:

In step 3, once application-level call control software 704 has completed sending its initialization information (after application-level call control software 704 has completed initialization of its finite state machine and restore card operations), it sends a message to the system manager. The system manager is a process that can reside on any card that performs system-level management, such as maintaining information regarding card status, shelf status, and software levels executing on each card. The system manager sends the message to lined process 702 of active card 200B, informing lined process 702 that initial configuration has been completed. The message exchanged between the system manager and lined process 702 may be generated using the following function call:
Send(LINED_PID, tSmSubAswCfgDone, 0);
   In the function call, the first parameter is the destination process ID. The second parameter is the message type. The third parameter indicates the number of parameters that follow.

When lined process 702 of active card 200B receives this message, the message may trigger lined process 702 of active card 200B to send a message to lined process 702 running on substitution card 200C indicating that active card 200B has completed its self configuration.

Step 4:

In step 4, lined process 702 of active card 200B creates one or more messages that contain all of the configuration, alarm, and signaling information needed by substitution card 200C to take over the operations being performed by active card 200B. Lined process 702 of active card 200B may collect this information from its TMS DCB. Active card 200B may then send the one or messages via the message bus to substitution card 200C. The message may be sent using the following function call:
Send(genIPC(cardVirtualPid, subcardnum, 0), tmsSubstCardInfo, 2, tmsCardObj, seq);
// The tmsCardObj is the copy of the configuration, alarm, and
// signaling information from the active card that is sent to the // substitution card.
// “seq” is a sequence number to allow proper synchronization between this message and any data that arrives via the TDM bus.
   Step 5:

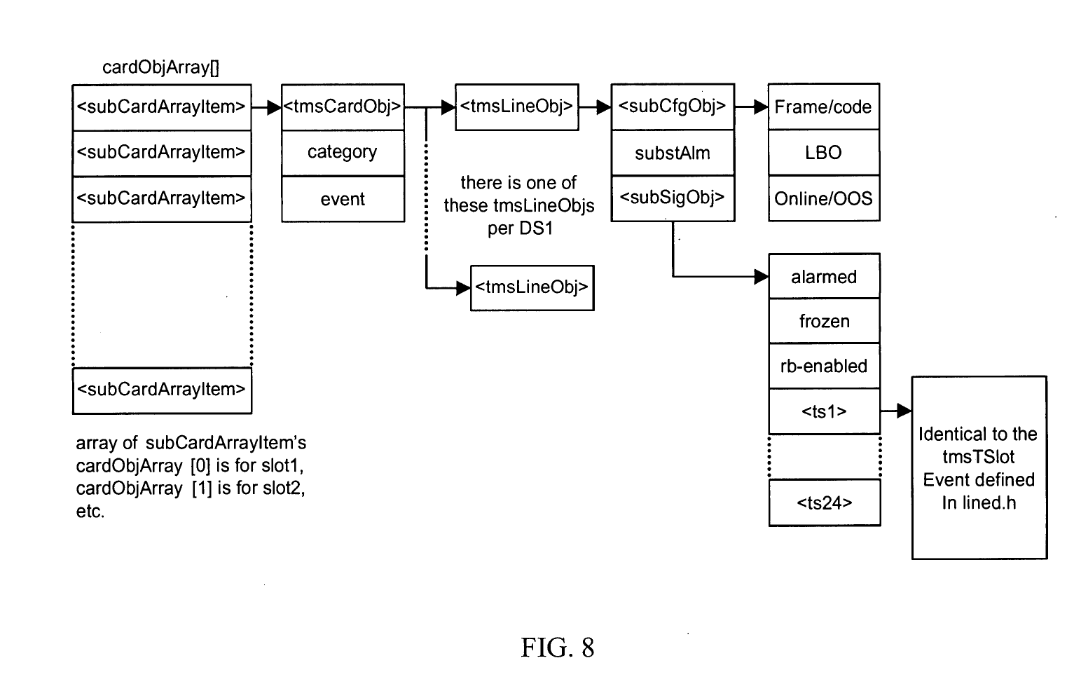

In step 5, when lined process 702 on the substitution card 200B receives the tmsSubstCardInfo event, it may set the appropriate element of the cardObjArray [symbol] with the subCardArrayItem received in that event. FIG. 8 illustrates an example of the cardObjArray [symbol] and the subCardArrayItem. The index into this array corresponds to the slot number this message is received from.

The memory used by a tmsCardObj varies based on card type. One card type, referred to by the assignee of the present subject matter as the LTC, implements 32 analog plus two DS1 channels. The LTC may use 7K (134K for 19 copies). Another card type, referred to by the assignee of the present subject matter as the TIC, includes 16 DS1 channels. The TIC may use 56K (1.07 Mb for 19 copies). Another card type, referred to by the assignee of the present subject matter as the BIC, implements 3 DS3 channels. The BIC may use 296K (1.18 Mb for 4 copies).

Once lined process 702 of an active card receives an aswCfgDone and sends its tmsSubstCardInfo, it may pass on to the T−1 phase. Lined process 702 can handle receiving a subsequent aswCfgDone message. In response to such a message, lined process 702 may take a snapshot of the TMS DCB 700 and send it to the card specified in the yourSubCard message, which was received during the T−2 phase. This may happen if the substitution card moves, or a new database was loaded.

2. T−1 and Holding Phase

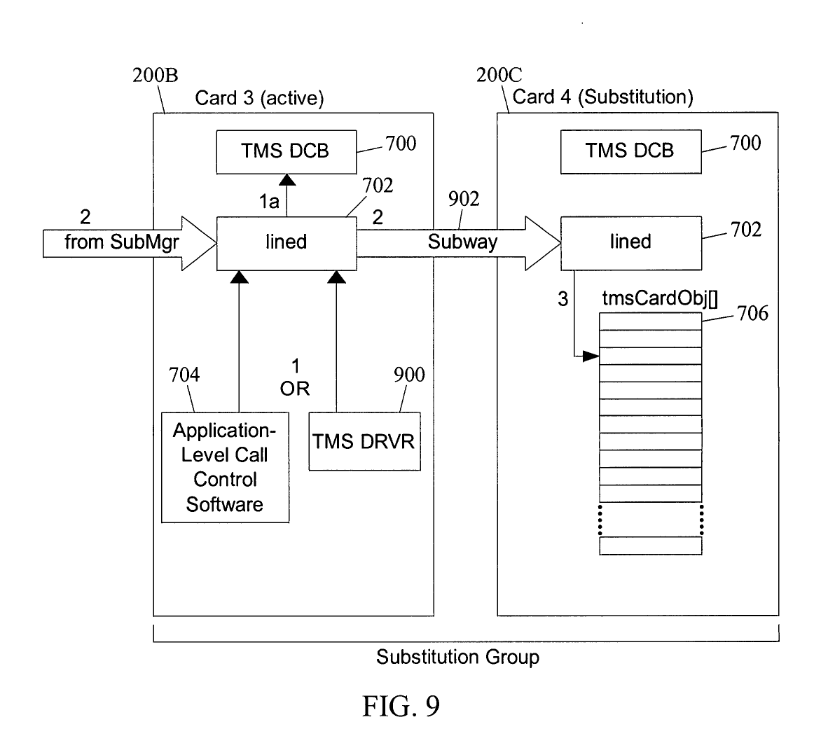

The T−1 and Holding phase of any active card may commence once the copy of the tmsSubstCardInfo event has been sent to the substitution card. The fact that the active card receives the yourSubCard event implies that the substitution card is ready. Lined process 702 on active card 200B may mark that this event occurred and, going forward, lined process 702 on active card 200B may be responsible for updating the information of the tmsCardObj on its substitution card 200C. FIG. 9 illustrates exemplary steps that may occur during the T−1 and holding phase. The steps described below correspond to the numbered arrows in FIG. 9.

Step 1:

In step 1, lined process 702 of active card 200B can receive information from an application, like application-level call control software 704, or from TMS driver 900. The type of information it receives may also need to be synchronized with substitution card 200C and fall into one of the following categories:
Configuration (anything that arrives in this phase)
Signaling information (only non-transitional events like ONHOOK or OFFHOOK)
Alarm State change information
   This type of messaging may be the same type of information currently communicated between application-level call control software 704 and lined process 702 on each active card.
   Step 1a:

In step 1a, lined process 702 of active card 200B may update TMS DCB 700 of active card 200B.

Step 2:

In step 2, since active card 200B knows that it is in the T−1 phase, it may send the new information, via a DSP/TDM link 902, to lined process 702 of substitution card 200C. The messages may be in a different format than what is received for two reasons. First, the messages may adhere to the 128-byte packet length limit of DSP/TDM link 902. Second, the format of information in tmsCardObj 706 may be different from TMS DCB 700.

Step 3:

In step 3, when the message is received by lined process 702 of substitution card 200C, lined process 702 of substitution card 200C may set the appropriate information in tmsCardObj array 706. This may ensure that substitution card 200C is ready for a substitution event.

The following sections describe exemplary signaling, alarm, and configuration information that may be transferred to substitution card 200C to prepare substitution card 200C to take over the operations performed by active card 200B.

2.1 Configuration Changes

All configuration changes may be sent from application-level call control software 704 to lined process 702 on each active card. Any configuration change that arrives after the aswCfgDone message is received may be forwarded to substitution card 200C. The following sections describe the configuration information that application-level call control software 704 may provide.

2.1.1 DS3 Configuration (BIC only)

DS3 Line Configuration
Framing (C-bit or M13)
Line coding (B3ZS only)
Line build out (in ft.)
Channelized (set to true)

DS3 Set Side
Network side (1) or user side (0). Network side is the default.

Loopback states
Disable/enable remote loopback
Disable/enable local loopback
   2.1.2 DS1 Configuration

Span (DS-1) Configuration
Framing (ESF, D4)
Line coding (B8ZS, AMI)
Line build out (in ft.)
Transmit elastic store (enable/disable)
Receive elastic store (enable/disable)

DS1 Set Side
Network side (1) or user side (0). Network side is the default.

Loopback states
Disable/enable line, local, framer, and payload loopbacks
   2.1.3 DS0 Configuration

Signaling Model Registration (May be performed even if all trunks are clear channel)
E&M
Loop start
Ground start

Trunk (DS-0) Configuration
Trunk number (relative within the span, ie. 1-24)
Model (E&M, Loop Start, Ground Start)
Sub-model (0)
   2.2 Signaling Information

Signaling information can be transmitted (from call processing) or received (as a result of call processing from the far end). During normal call processing of channel associated signaling (CAS) trunks, the application-level call control software will send Transmit Signaling information to the line daemon. Only non-transitional signaling events will be forwarded to substitution card 200C. This means that OnHook and OffHook events may be forwarded, but Winks and Flash Hooks may not be forwarded. When the event is forwarded to substitution card 200C, it will update the substitution card's tmsCardObj 706 for the card from which substitution card 200C received the event. A signaling command may contain the following information:
Span number
Trunk number (relative within the span, ie 1-24)
Signal ID (e.g., EANDMS_ONHOOK)

Receive signaling changes detected by the TMS will be sent to the application-level call control software 704. If the event is a non-transitional event (OnHook/OffHook), then the event will be forwarded to substitution card 200C. When the event is forwarded to substitution card 200C, it will update the substitution card's tmsCardObj for the card from which substitution card 200C received the event.

The rules for transmit and receive signaling information are sufficient to support stable two-way calls in case there is a substitution event. Although a non-transitional event could occur prior to a stable two-way call, auditing performed in the T+1 phase will determine if this was part of a stable call or not.

Signaling information may be queued up if the application sends multiple signaling events for a given trunk prior to any signal complete indication. The TxSigProc process, not shown, is responsible for properly sequencing these events so that a TXSIGOVERFLOW error does not occur. Even though non-transitional events may be queued up, the queue will not be preserved.

2.3 Alarm Status Changes

Similar to signaling, alarm status can be transmitted and received. Since the TMS does all of the alarm qualification, the alarm information is considered stable when it is received or transmitted. The TMS will forward all qualified alarm state changes to its substitution card. Substitution card 200C will update the copy of DCB 700 for the card from which it receives the message.

3 Card Failure

A card failure occurs either as a result of a software or hardware failure, or due to a manual switchover that is part of a rolling substitution procedure. The Substitution process will send a message to lined process 702 on all cards, including the substitution card 200C, to inform it which card has failed, the message will be:
Send(cardVirtualPid, tSubMgrSubstitute, 2, fromCard, toCard);
   The message will be a trigger to move to the T+1 phase next.
   4 T+1 Phase

The substitution process may detect the card failure and may be responsible for notifying the TMS as to which card has failed. The TMS may attempt to synchronize with the information it received from the card that just failed. All information for the failed card may be located in the tmsCardObj associated with that card.

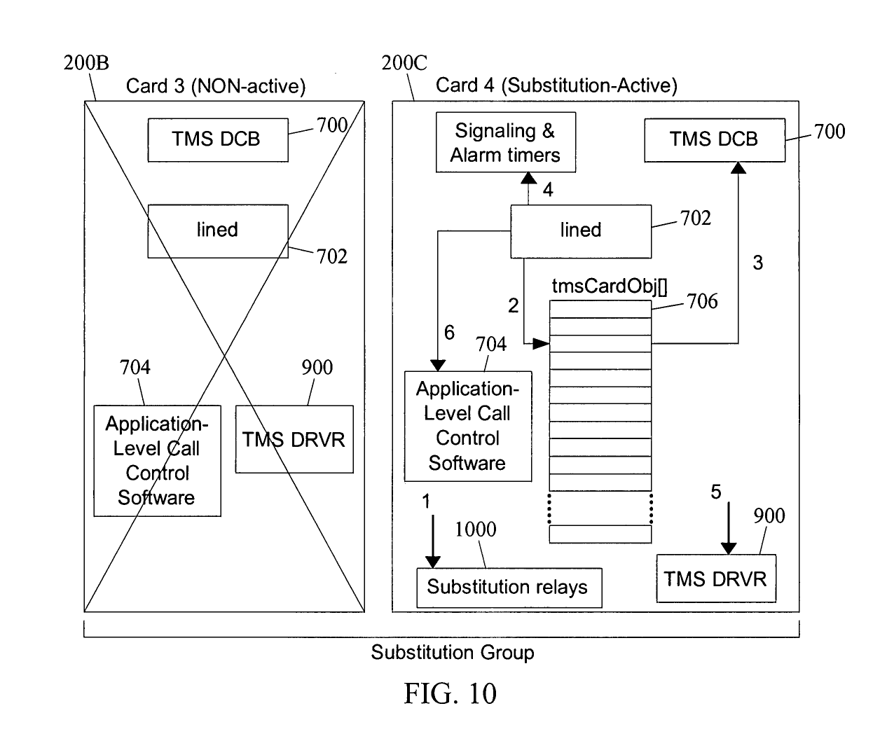

It is important that all the steps in this phase occur very quickly, i.e., on the order of milliseconds or tens of milliseconds. In this phase, it is desirable to ensure that the alarm and signaling states do not incorrectly reflect the condition of a span or a trunk. For example, it is desirable that the framers not be in an improper state and make the far end think that substitution card 200C is in an alarm state, such as a loss of signal (LOS) alarm state. It may also be desirable not to make the far-end or near-end think it has received a FLASH or a WINK. It is also desirable that the trunk management software of substitution card 200C be in a ready state to allow the application-level call control software to audit and re-establish stable calls. FIG. 10 illustrates exemplary steps performed in the T+1 phase. The steps described below correspond to the numbered arrows in FIG. 10.

Step 1:

In step 1, the substitution process may detect a card failure and may inform lined process 702 of substitution card 200C. The failure may be detected by the absence of health check acknowledgement messages from the active card in response to health check messages sent by another card. In one implementation, a DSP on one of the active cards may send health check messages to active cards over a TDM channel and wait for responses. If a response is not received within a timeout period, the DSP may inform the substitution process. In response to detection of the failure, substitution relays 1000 may be switched to substitution card 200C and off with respect to failed card 200B. The trunk management software on substitution card 200C may switch the relays on I/O module 202C (from FIG. 2) associated with the substitution card. On LTCs, the TMS may send a message to the SLIC controller to switch relays associated with analog subscriber lines maintained by the SLIC controller.

Step 2:

In step 2, now that lined process 702 of substitution card 200C knows which card failed, it may lookup tmsCardObj.706 for failed card 200B.

Step 3:

In step 3, lined process 702 of substitution card 200C may convert the tmsCardObj 706 and update TMS DCB 700 with its information.

Step 4:

In step 4, lined process 702 of substitution card 200C may start signaling and alarm timers. Prior to this phase, these timers were not set and no polling was being performed. Although these timers are being re-armed, if there are any signaling or alarm changes, they may be queued up and sent after lined process 702 receive a message from application-level call control software 704 indicating that application-level call control software 704 has begun to audit the TMS.

Step 5:

In step 5, TMS driver 900 of substitution card 200C may get updated with the information in DCB 700 of substitution card 200C (affects actual registers in the drivers). When substitution card 200C is in standby, the transmitters are off. The transmitter of substitution card 200C may be turned on.

Step 6:

In step 6, lined process 702 of substitution card 200C may send the following message to application-level call control software 704 of substitution card 200C to indicate that lined process 702 of substitution card 200C is ready to be audited. The following function call may be used to send the message.
Send(tp_pid, tmsAuditRdy, 0);
   The first parameter of the message is the destination process ID. The second parameter is the message type. The third parameter is the number of parameters that follow.

Once the tmsAuditRdy message is received by lined process 702 of substitution card 200C, this indicates a transition to the T+2 phase.

5 T+2 Phase

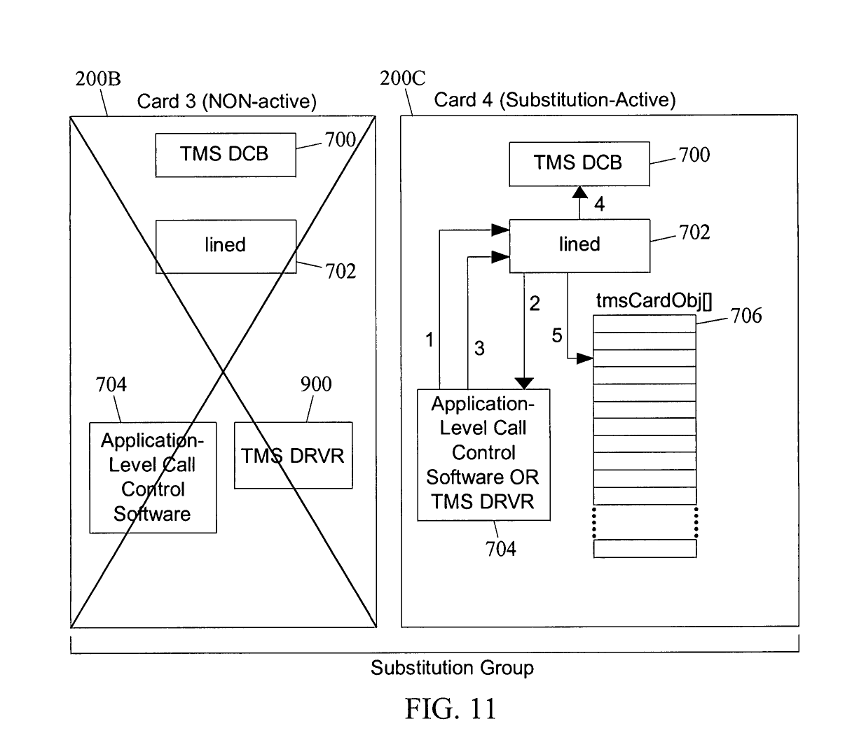

In the T+2 phase, substitution card 200C has taken over the operations that were performed by active card 200B. The TMS of substitution card 200C may process events normally. Substitution card 200C, which is now active, is ready for any auditing needed by call processing to maintain stable calls (see the next section for details on the interface). As in phase T−1, substitution card 200C may update the tmsCardObj of the failed card. This may allow a subsequent switch back (reverting off the substitution card back to the card that failed but has since been restored). FIG. 11 illustrates exemplary steps that may occur during the T+2 phase. The steps below correspond to the numbered arrows in FIG. 11.

Step 1:

In step 1, once lined process 702 of substitution card 200C has sent its audit ready message, it may wait to receive a message from application-level call control software 704 to audit the state of alarms and signaling.

Step 2:

In step 2, once lined process 702 of substitution card 200C receives the audit request message, it may start sending the alarm state information followed by the signaling state information. To improve performance, it may only send signaling information for trunks that are in spans that are not in alarm and trunks that are configured as CAS trunks. The last message it sends may be an audit complete message back to applications. Once lined sends a reply, for a given signaling trunk state, it may make that trunk active again and any future signaling state changes may be passed to applications as it does normally.

Step 3:

In step 3, as in the T−1 phase, events are received by the lined process from an application (application-level call control software) or the TMS driver, and these events may be updates to configuration, alarm state, and signaling state.

Step 4:

In step 4, lined process 702 of substitution card 200C may update its own copy of the TMS DCB 700 of substitution card 200C, since substitution card 200C is now the active card.

Step 5:

In step 5, active substitution card 200C may still maintain tmsCardObj 706 for the card for which it has taken over operations. Lined process 702 of substitution card 200C may update the information in tmsCardObj 706 of substitution card 200C. This updating may be performed so that a complete resynchronization need not be performed after a switch back operation.

5.1 Auditing Interface

The application software will audit the TMS for state information with regards to signaling and alarms. This section provides the interface between the TMS and the application software to allow the application software to quickly process the state of signaling and alarms.

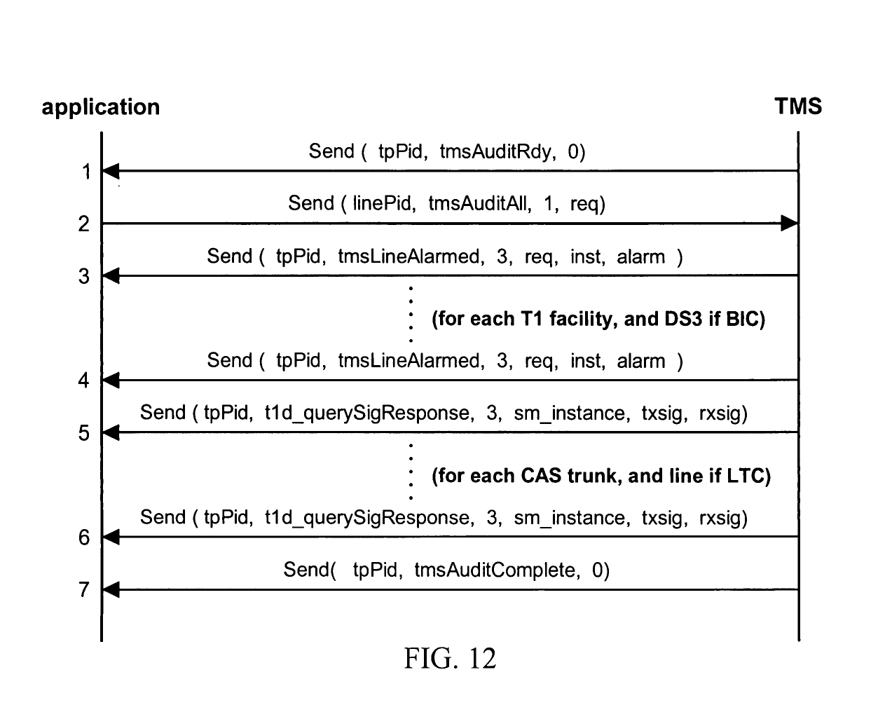

After the TMS has sent its audit ready message, the application will send an audit TMS request. The request will respond with the alarm and signaling information for all spans and trunks. When the audit responses have completed, the TMS will respond with an audit complete message. This messaging exchange is pictured in FIG. 12.

This interface has been benchmarked and showed the following results.

| Card Type | Audit Interface |
|---|---|
| LTC (48 trunks plus 32 | 23 ms |
| lines) | |
| TIC (384 trunks) | 10 ms |
| BIC (2016 trunks) | 402 ms |

The following sections describe an exemplary audit interface that allows finer control of auditing. For instance, a single span can be audited for its alarm state. A single trunk's signaling state can also be obtained. These sections also provide additional details regarding the messages used to perform the auditing.

5.1.1 Alarm Interface

The first thing the application software should audit is the status of alarms. It is possible that active card 200B was in alarm prior to the substitution event, and it is important that application software maintain that information. If any T1 facility is in alarm, then signaling auditing can be skipped or postponed, since no active calls could exist when a facility is in an alarm condition.
int getDS1AlarmState(OID oidinst)
int getDS3AlarmState(OID oidinst)

On LTCs and TICs, the application software may call the “getDS1AlarmState” function directly for expediency. The BICs may use the message interface for this information since the TMS and application software is running on separate cards of the BIC (the BIC is a two-slot card). The functions will return a one if any alarm condition is set (logical OR of all alarm conditions) or a zero if there is no alarm condition. The application software can then use the current polling interface to get specific information if there is an alarm present. If there is an alarm, then it is important, that the application does poll for the condition of the alarm, since no message will be sent to the event report process until there is a state change. This polling may be performed after all facility alarms and signaling has been audited first.

The message interface to audit a T1 facility's alarm state is as follows:
Send(cardVirtualPid, t1d_spanPOLL, 3, inst, TE1LPOLL_ANYALARM, req)

The TMS will respond back to the sender with the following message:
Send(msg→src, tmsLineAlarmed, 3, req, inst, alarm )

The msg→src is the sender of the original POLL request. The “requestor” should be a state machine instance. The “inst” is the OID instance sent with the original request. The “alarm” parameter will be the OR of all possible alarm conditions.

The message interface to audit a DS3 facilities alarm state is as follows:
Send(lined_pid, ds3_linPOLL, 3, inst, DS3LPOLL_ANYALARM, requester)

The TMS will respond back to the sender with the following message:
Send(msg→src, tmsDs3Alarmed, 3, requestor, inst, alarm)

The msg→src is the sender of the original POLL request. The “requester” should be a state machine instance. The “inst” is the OID instance sent with the original request. The “alarm” parameter will be the OR of all possible alarm conditions.

The applications may also get a snapshot of all the current alarm conditions by sending the following message:
Send(lined_pid, tPostCurrentAlarms, 0);

The TMS will send alarm notifications, one per alarm, for any alarm condition that is ON using the tEventReport message.

5.1.2 Signaling Interface

The signaling interface between the TMS and application software will allow both a direct function interface as well as a message interface. For expediency, on LTCs and TICs, the application software should use the direct function interface, which is defined below (SIG_AUD is in the target.h include file):

void getLastSignal(OID oidinst, SIG_AUD *siginfo) typedef struct

```
void getLastSignal(OID oidinst, SIG_AUD *siginfo
typedef struct
{
  int txsig;
  int rxsig;
} SIG_AUD;
```

The message interface will be defined as follows:
Send(cardVirtualPid, t1d_querySigEvent, 1, inst);

The “inst” will be the object ID (OID) of the trunk being audited. To be consistent, it will also be the interface for the line facilities (SLIC lines). The oidinst in the case of lines will be of the OID index tLineIndex. When the TMS receives this message, it will check the signaling information in its DCB and return with the following message:
Send(msgp→src, t1d_querySigResponse, 3, sm_instance, txsig, rxsig);

The “sm_instance” will be calculated as it is with all signaling events received by the TMS and will be the state machine instance for the trunk being audited. The remaining parameters are transmit and receive signaling information.

Benchmark testing was performed to test the performance of the signaling interface. The results are listed below.

| | Direct function | |
|---|---|---|
| Card Type | calls | Messaging |
| LTC (48 trunks plus 32 | 7 ms | 68 ms |
| lines) | | |
| TIC (384 trunks) | 5 ms | 28 ms |
| BIC (1344 trunks) | NA | 1011 ms |

6 Switch Back

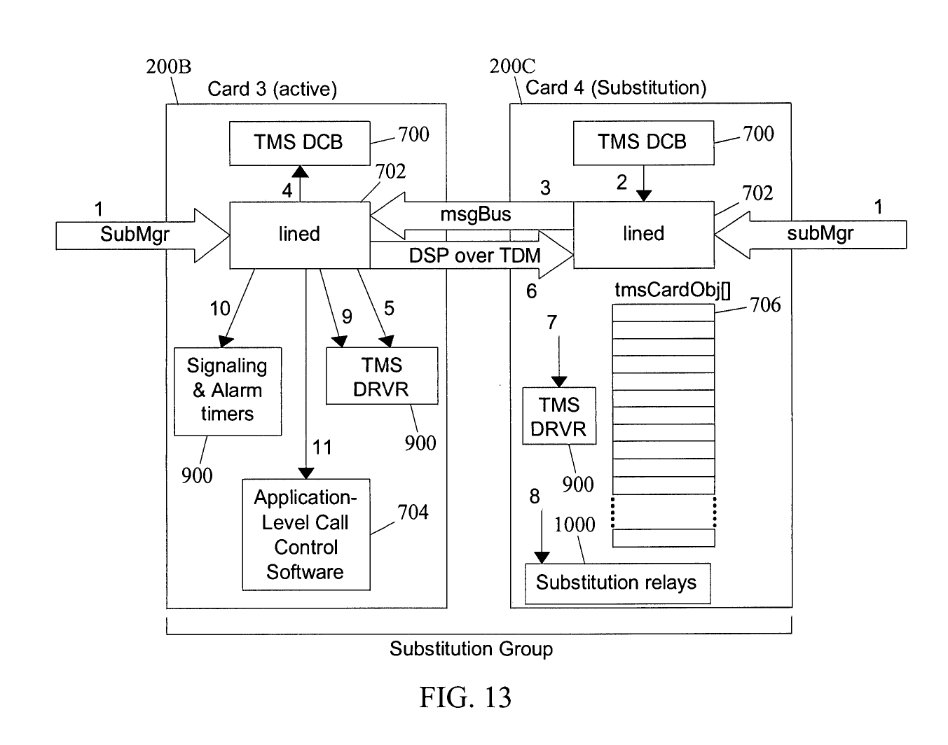

At some point the failed card may be restored, and a “switch back” from the substitution card to the newly restored card can occur. A switch back may be similar to a card failure, except a more controlled environment exists in that the time of the updating can be controlled by the switch operator. FIG. 13 shows exemplary steps that may be performed for a switch back event. The steps described below correspond to the numbered arrows in FIG. 13.

Step 1:

In step 1, the substitution process may send a message indicating that there is a switch back event. The message may be sent to all cards in the switch, including the lined process on both the substitution card and the card being switched back to. In this section, the card being switched back to will be referred to as the toCard and the card being switched from will be referred to as the fromCard. The following function call illustrates exemplary parameters that may be included in the switch back message:
Send(cardVirtualPid, tSubMgrSubstitute, 2, fromCard, toCard);
   As illustrated in the function call, the switch back message may specify the fromCard and the toCard. The switch back message may also include an identifier, referred to as the cardVirtualPid, that identifies processes registered to receive an event. The tSubMgrSubstitute parameter identifies message type. The “2” parameter indicates the number of parameters that follow.
   Step 2:

In step 2, lined process 702 of fromCard 200C may collect its entire TMS DCB 700, which is a snapshot of the current configuration of the TMS and creates the object to be sent to toCard 200B. Lined process 702 of fromCard 200C may also stop its signaling and alarm timers.

Step 3:

In step 3, lined process 702 of fromCard 200C may send the TMS DCB to toCard 200B. This message is large and may be transported via the message bus.

Step 4:

In step 4, lined process 702 on toCard 200B may receive and replace its own copy of the TMS with what it received from the substitution card (fromCard 200C). This means that whatever configuration was set up on toCard 200B while it was booting may be overwritten with the latest state of the substitution card (fromCard 200C). This should allow configuration changes made after a substitution card becomes actives to be preserved after a switchback event.

Step 5:

In step 5, the lined process of toCard 200B may take the configuration of the DCB and set the driver registers appropriately.

Step 6:

In step 6, lined process 702 on toCard 200B may send a message to from card 200C to indicate it is ready to switch the relays. The message may be sent via the DSP/TDM messaging system.

Step 7:

In step 7, TMS on the substitution card (fromCard 200C) may be commanded to shut off the transmitters of all the framers. This action may be performed to reduce hardware noise (namely with the TIC).

Step 8:

In step 8, substitution relays 1000 are switched over from fromCard 200C to toCard 200B. Any queued up configuration or signaling/alarm state information that has occurred on fromCard 200C since step 1 may be sent over to toCard 200B.

Step 9:

In step 9, lined process 702 of toCard 200B may turn on the transmitters of each framer.

Step 10:

In step 10, lined process 702 of toCard 200B may start the signaling and alarm poll timers 900.

Step 11:

In step 11, lined process 702 of toCard 200B may send an audit ready message to its application-level call control software so that the software knows it can perform an audit, as in the “T+2” phase, and can continue with its call processing.

After any auditing is completed, toCard 200B enters a “T−1 and Holding” phase of processing, with respect to the TMS.

II. Inter-Card DSP Messaging System

As stated above, in order to ensure that messages relating to card substitution are delivered with high reliability and low latency, a DSP and a TDM bus may be used. The message system that uses the DSP and the TDM bus is referred to as the inter-card DSP messaging system. It is also referred to in some of the code examples below as the subway or subway message system. Details of this message system will now be described.

1 Summary

The inter-card DSP messaging system may be used to send state updates from sysMon or the TDM, T1, and HDLC device drivers to a substitution card. It may not use the existing message bus but instead route the information using DSPs and the TDM midplane. Each card may have a dedicated set of timeslots on the midplane for transmitting the information. Substitution cards and other interested parties may eavesdrop on the cards to receive messages and maintain states.

Substitution messages may be sent using a special route called subwayPid similar to cardVirtualPid. The messages may be routed in sendmsg( ) to a process referred to as the inter-card DSP messaging process. The inter-card DSP messaging process may transmit the messages out the DSPs to any listening substitution cards or other monitor cards. The messages received on the substitution card may be resent using cardVirtualPid to any daemon registered to receive them.

State information may be limited to messages whose body is 128 bytes or less. The substitution messaging system is not intended to be used for sending large messages. The existing message bus should be used for large messages. Fragmentation and re-assembly of large messages is not available inside the driver.

Forward error correction may be performed by sending each packet twice. The second copy may use a different midplane bus. Initially the same DSP may be used but the design may grow to use multiple DSPs. If the first packet does not pass a checksum test it may be discarded and the second copy may be used. This may correct for any momemary TDM clocking problems or bad TDM buses. This form of error correction is more appropriate than ACKing like the message bus because there may be multiple listeners.

2 Design Details

2.1 Sending Messages Over the TDM Midplane Using DSP Messaging

A number of different processes may use the inter-card DSP messaging system to broadcast data usually to listening substitution cards. For example, a system monitor process may be running to check the status of application-level call control software, memory usage, and idle cpu time, a TDM process may be connecting and disconnecting lines, and lined (Trunk Management Software) may be monitoring signaling on trunks.

A new message destination type similar to cardVirtualPid called subwaypid may be used to Send( . . . ) to any listening substitution card. Then msg.c, which contains the source code for sending messages, may be modified to send these messages to the inter-card DSP communication process daemon for transmission using the DSPs. The following function call may be used to send messages over the inter-card DSP messaging system:
Send (subwayPid, tExampleEvent, . . . );
   The inter-card DSP messaging process on the active card may send these messages through the DSP and TDM bus to any listening cards.

The inter-card DSP messaging process on the receiving substitution card may reconstruct the message from the data and send it to the card virtual process id (cardVirtualPid). The following function call may be used to send the message. In the function call, the first parameter is the card virtual process ID. The second parameter is the message type. Any remaining parameters will be specific to the event being communicated.
Send (cardVirtualPid, tExampleEvent, . . . );
   The processes on the receiving card expecting these messages may have registered to receive tExampleEvent.

Messages to the substitution card may be restricted to 128 bytes. 128 bytes accommodates TDM, T1, and HDLC message lengths. Any large messages should be sent using the message bus. This substitution messaging system should only be used for sending updates to the substitution card.

The substitution messaging systems may not use acking to check that a message arrived at the far end. For this reason, it may not be desirable to employ the technique of segmenting large messages up into smaller ones for transmission. If messages are broken into smaller messages for transmission and a message is lost, the complete packet would be lost. For this reason, it is desirable to send messages that are greater than 128 bytes over the message bus and to use the inter-card DSP messaging system for individual updates.

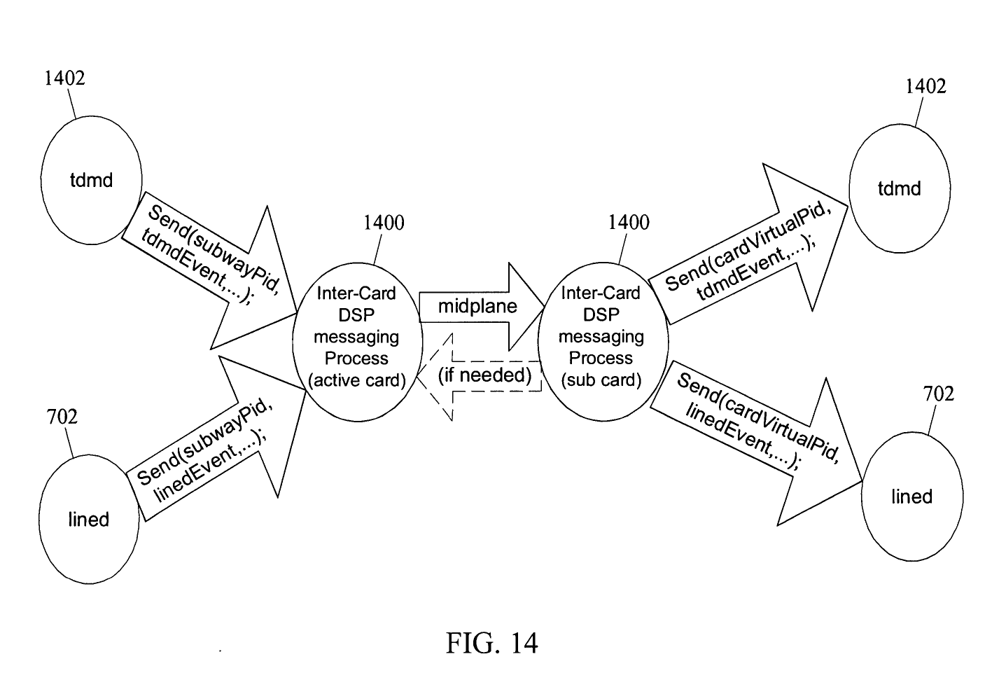

In one exemplary implementation, a process may execute on each card to control message communication over the TDM midplane. This process is referred to as the inter-card DSP messaging process. FIG. 14 shown below illustrates an example of messages being transferred between inter-card DSP communication processes.

2.2 Inter-card DSP Communication Process

Inter-card DSP messaging process 1400 may start after a DSP server, which executes on each card that includes one or more DSPs to control the DSPs. Each inter-card DSP communication process 1400 may sit in a receive loop waiting for 1) data for transmission to substitution cards, 2) received data from active cards to deliver to waiting processes, and 3) control events. In FIG. 14, TDM process 1402 and lined process 702 on the active card transmit data via the inter-card DSP messaging system to the corresponding processes on the substitution card.

Each inter-card DSP messaging process 1400 may open four (two on an LTC) DSP transmit devices, one per TDM bus, for transmitting through the DSPs and connecting them to their TDM midplane timeslots. At this point each inter-card DSP communication process 1400 may be ready to transmit data to be passed to any listening substitution card.

Data may be packed into an object suitable for transmission by the DSPs. It may include a sequence number and flag indicating original or copy. Each inter-card DSP messaging process 1400 may send the message and its copy to two different DSPs for transmission (forward error correction).

Inter-card DSP messaging processes 1400 on substitution or switchback cards can receive a message from subMgr to open DSP receive devices for cards in its substitution group. These receive devices may send received packets up to inter-card DSP messaging process 1400 where they may be screened to keep only one copy of each message. Error statistics may be maintained. Messages may be constructed and sent to cardVirtualPid for delivery to waiting daemons. Events not registered for on the receiving card may be dropped.

2.3 Midplane TDM Messaging Channels

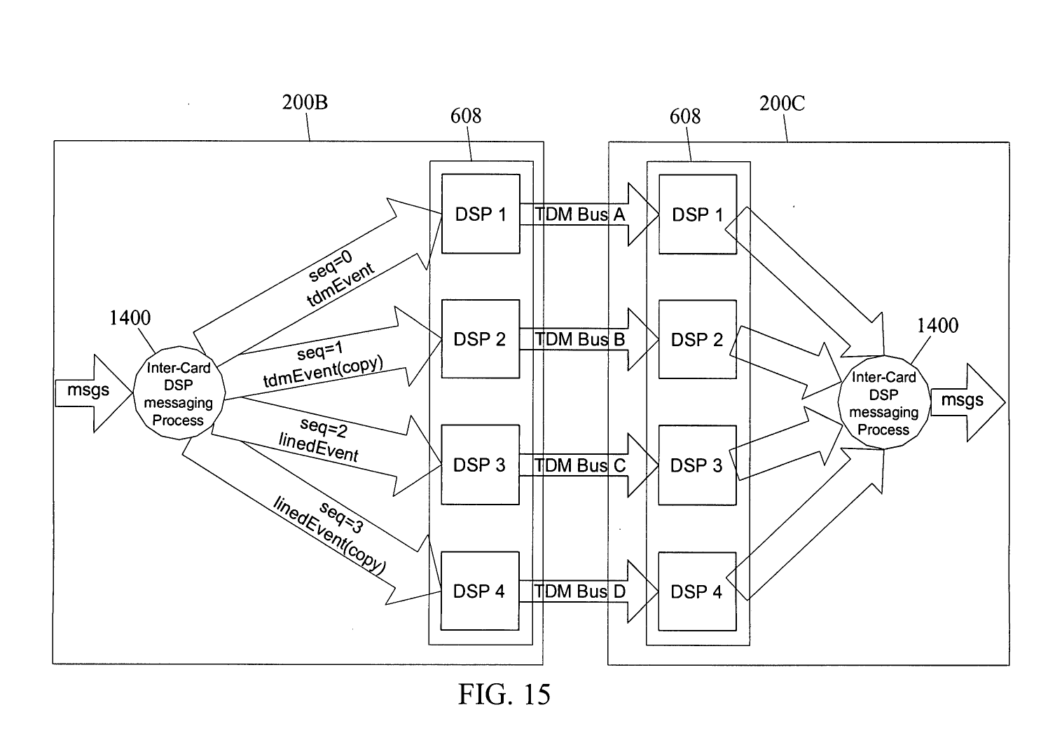

Each card may set up N messaging channels where each channel is a single TDM 8 bit midplane channel (64 kBits/sec) and N is an integer configurable by the switch operator. In the example illustrated in FIG. 15, four TDM channels are utilized, one from each of the four TDM midplane buses. This design is based on N×1×DS0. Opening more TDM channels may not speed up the transmission of any single message. Each message may be sent at a rate of 64 kBits/sec. It may increase the throughput of messages.

In FIG. 15, inter-card DSP messaging process 1400 on active card 200B receives messages from the processes executing on active card 200B. The messages are load shared over four DSP channels and sent over the TDM bus to substitution card 200C. The inter-card DSP messaging process 1400 resident on substitution card 200C receives the messages and delivers the messages to the processes executing on the substitution card.

Each card may use TDM-cardNum as its first tdm midplane timeslot. For example; card 1 may use TDM-1, card 20 may use TDM-20. The timeslots being used may be removed from the TDM Server's cache of timeslots. For redundancy, the first 20 timeslots from each of the four midplane busses may be used for inter-card DSP messaging. If one bus goes down, the other three may be available. Knowledge of when a bus is bad may need to be determined elsewhere and sent to the inter-card TDM messaging system.

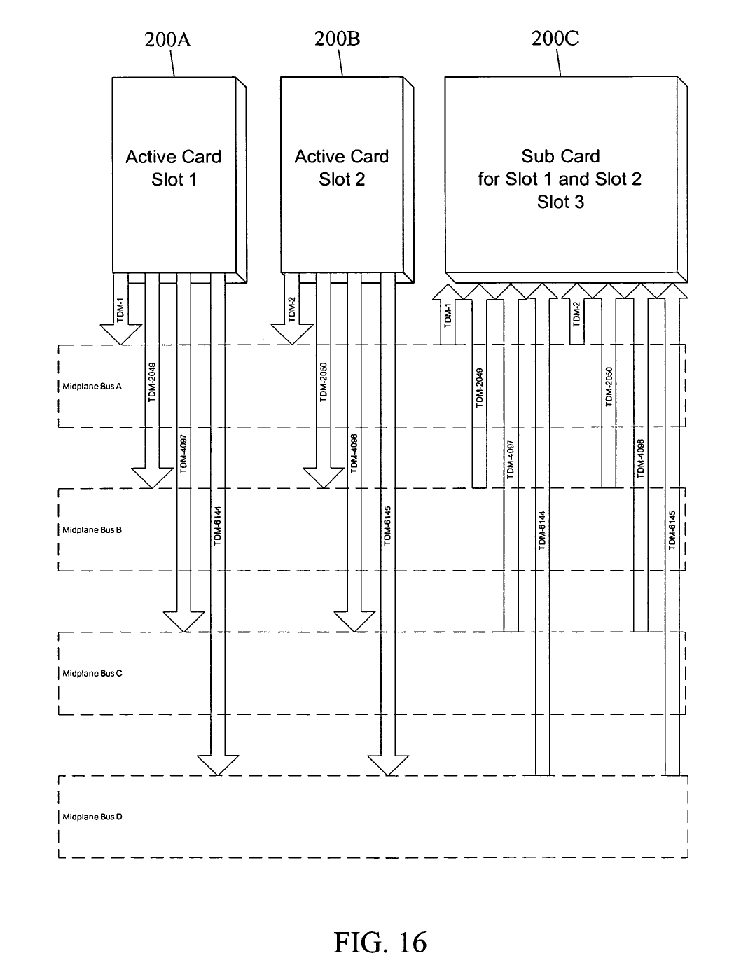

FIG. 16 illustrates an exemplary allocation of TDM channels between cards. In the illustrated example, active card 200A uses TDM channel TDM-1 on midplane bus A, TDM channel TDM-2049 on midplane bus B, TDM channel TDM-4097 on midplane bus C, and TDM channel TDM-6144 on midplane bus D. Similarly, active card 200B uses TDM channel TDM-2 on midplane bus A, TDM channel TDM-2050 on midplane bus B, TDM channel TDM-4098 on midplane bus C, and TDM channel TDM-6145 on midplane bus D. Substitution card 200C listens to the TDM channels used by cards 200A and 200B.

2.4 DSPs

2.4.1 DSP Messaging Device—DSP_MSG_Control, DSP_MSG_Read, DSP_MSG_Write

DSP messaging devices may provide a control, read, and write interface for inter-card DSP communication process 1400 to use for passing and receiving packets from the TDM bus. Individual devices may be opened for each TDM channel for both transmit and receive. In this context, a DSP messaging device is a software object created to provide access to DSP hardware.

Messages may be transmitted from inter-card DSP messaging process 1400 to the DSP using a write (device, *ptr, bytes). The device may remain open and packets can be sent asynchronously. No acknowledgement is necessary with the transmissions. A finish message indicating the DSP is ready for the next packet may propagate from the algorithm to the device to prevent overwhelming the DSP with data.

Packets may be received by inter-card DSP messaging process 1400 from an opened receive device. The read( . . . ) option may not be available. The open command may set the destination and instance. The following pseudo-code illustrates the open, transmit, and receive commands.
loadDevice N $DSP_MSG_Control $DSP_MSG_Read $ywrite 0 open {N}<direction><sendDst><sendType><sendInstance>
// transmit from inter-card DSP messaging process 1400 to device write (device, *ptr, bytes);
// receive from device to inter-card DSP communication process 1400 Send(sendDst, sendType, 2, sendInstance, BuildBinary (DSPRxMsg, sizeof(msg), ptr));
   2.4.2 Inter-Card DSP Transmit Algorithm

The DSP messaging channel may include two algorithms—a transmit algorithm and a receive algorithm, each of which may be implemented by inter-card DSP messaging process 1400. The transmit algorithm may transmit messages out to the TDM stream. Each instance of the algorithm started on a DSP returns a TDM OID on the internal card TDM bus. This OID may be connected to the appropriate TDM-cardNum for each bus.

The message format will be described in section 2.4.4. The transmit algorithm may add a header and checksum to the data received from the DSP Server. Optionally, it may insert 0xde after any 0x7e (flags) found in the message to keep false start detections from occurring. The message may then be sent over the TDM stream. When complete, a finished message may be sent to the controlling device. This message may trigger the sending of any queued messages for transmission.

When no messages are available for transmission, an ‘alive’ message may be transmitted indicating that the DSP is up and running. The controlling device is not involved. The substitution card can use this message to determine that the card is still up. SysMon may also be sending periodic messages. A card's state may be determined as follows:
1) sysMon messages—Host and DSPs are running
2) DSP alive messages—DSPs running, Host may be down.
   2.4.3 Inter-Card DSP Receive Algorithm

The second algorithm may be the inter-card DSP receive algorithm. The inter-card DSP receive algorithm may receive blocks of data and parse through the data looking for a message. If a valid message is found it may be packaged up and sent to the inter-card DSP message receive device (through the DSP Server). Corrupt packets may be dropped.

The DSP txMsgSys algorithm must be capable of realizing when the sending DSP is not on-line. When this occurs, it may automatically send a unique message to the substitution card indicating a problem exits.

2.4.4 Inter-Card DSP Message Format

In one exemplary implementation, messages sent between cards may include fields that are composed of bytes, rather than bits of data. The idle pattern may be 0x7e (flags). No bit shifting may take place. In order to prevent improper detection of a packet start, all flags (0x7e) when inside a packet may be followed by <0xde>. The 0xde may be deleted when it follows a 0x7e.

Example:

Data to Send: 43, 56, 7e, 87, f4

Modified for flags: 43, 56, 7e, de, 87, f4
(de removed when following 7e)

A valid packet start may be defined as the following pattern:
1) Flags byte, (0x7e)
2) Type byte, (0x01=message, 0x02=alive message)
3) Size byte, (<=140 bytes)
   The remaining bytes plus checksum are collected based on the size. The checksum is calculated using all bytes except the checksum. If the checksum is valid, the message is passed through the DSP Server to inter-card DSP messaging process 1400.

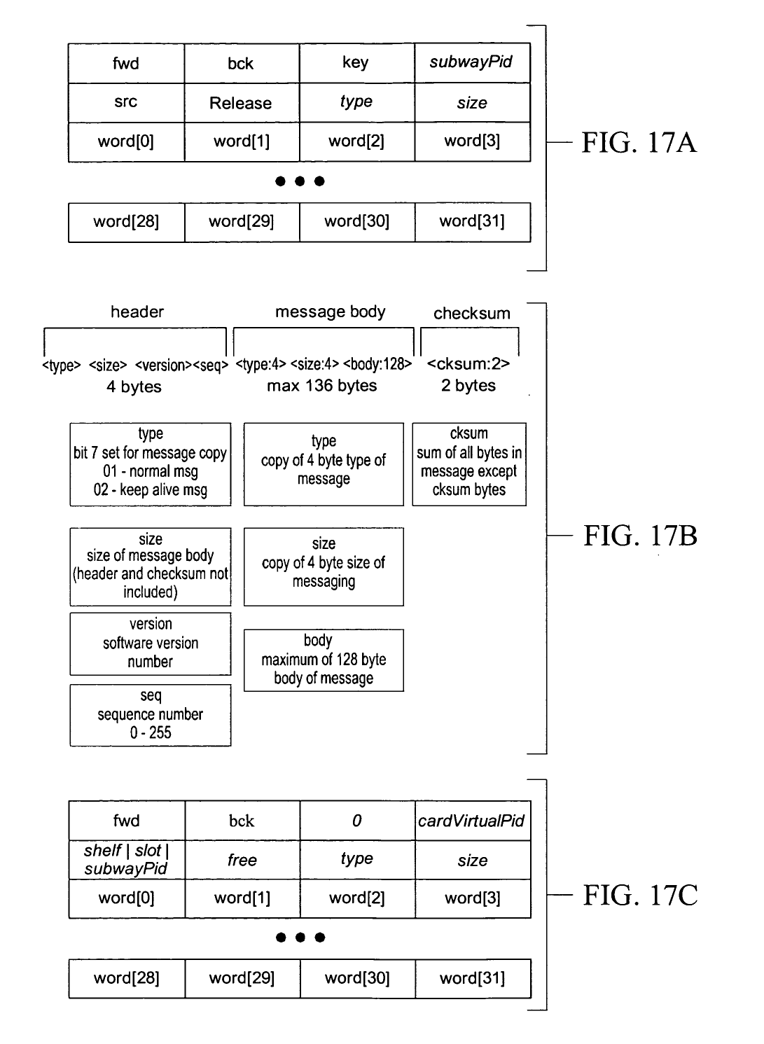

FIGS. 17A-17C illustrate exemplary message formats for inter-card DSP messaging according to an embodiment of the subject matter described herein. More particularly, FIG. 17A illustrates an exemplary message format for a message from a process resident on a card to inter-card DSP messaging process 1400. Each block in the message represents a field. FIG. 17B illustrates an exemplary format for messages transmitted between cards over the TDM bus. FIG. 17C illustrates a reconstructed message on the substitution card.

III. TDM Subsystem Operation for Card Substitution

Introduction

The following section describes exemplary steps that may be performed by the TDM interfaces of the active and substitution cars in performing card substitution. The TDM subsystem is responsible for allocating midplane timeslots for connections. Several groups of cards can be defined, where in each group, one of the cards can be used as a substitution for the others. The operation of the TDM subsystem with regard to card substitution will be described in phases ranging form T−2 to T+2 as defined above. In addition to these phases, this section may also describe the actions required to switch back the substitution card from active to standby and additional changes.

T−2 Phase.

Step 1.

The substitution process is responsible for configuring the different cards in the system. Each card may receive information about the substitution group where it belongs (lowest and highest card numbers in the group) and the card id of the substitution card.

Step 2.

When the application software has completed its initialization, it may send a message to a TDM process, also referred to herein as the TDM daemon or tdmd, to inform the TDM process that the configuration has been completed.

When the TDM process receives this message, it may send a list of its current connections (source, midplane, destination) to the substitution card. This message may be sent via the message bus.

The TDM process on the substitution card may be responsible for keeping a list of connections for each card in the substitution group.

T−1 Phase.

Each time a new connection or disconnection is made by a card in the substitution group, a message with the connection or disconnection information (source, midplane, destination) may be sent over the inter-card DSP messaging system to the substitution card. The TDM process on the substitution card may then update accordingly its list of connections for the concerned card.

Card Failure.

A substitution may result from a software or hardware failure or from a manual substitution procedure. The substitution process may send a message to the TDM process on the substitution card to inform it which card has failed. During the substitution phase, every new connection or disconnection request for the card being substituted may be queued until the substitution is complete.

T+1 Phase.

Step 1.

The TDM process on the substitution card may broadcast a message to all the cards in the system indicating that it is taking over for the substituted card.

Step 2.

On reception of the message described in step 1, each card in the system may go through their list of connections and accordingly update the corresponding end to the substituted card id.

Step 3.

The substituted card, if alive, may go through its connection list and may release the concerned midplane timeslots, sending them back to a TDM server, which controls allocation of TDM timeslots.

Step 2.

Going through the list of connections for the substituted card, new midplane timeslots may be used instead of the current ones if the substitution card becomes the new source for the connection; if the substitution card is the destination, it may simply connect to the existing midplane timeslot.

Each time a midplane timeslot is changed, a message may be sent to the card containing the other end of the connection. On reception of this message, the card at the other end of the connection may disconnect from the current timeslot and connect to the new one

Step 3.

All queued connections and disconnections requests may be processed.

Step 4.

When the substitution process is complete, a message may be sent to the application-level call control software to inform the application that auditing of TDM connections is available.

T+2 Phase.

Application software will audit all TDM connections. Events may be processed normally as the substitution card is expected to have completely replaced the failing card.

Switching Back to Original Card

When receiving a “switch back” command from the substitution process, the substitution card may send all connection information to the original card and may then be placed in standby mode, waiting for another substitution. The process may be identical to the first substitution.

IV. SLIC Card Substitution Operations

The SLIC driver is responsible for functionality of the SLICs, which are used for plain old telephony systems (POTS) traffic in a switch that implements card substitution according to an embodiment of the subject matter described herein. The only line card that has SLIC devices is the LTC. Therefore, all discussions regarding support for card substitution are specific to the LTC. This section describes the actions required to support card substitution, with regard to the SLIC driver and software that interfaces with it. The operation of the SLIC driver with regard to card substitution will be described with reference to the T−2 to T+2 phases defined above.

T−2 Phase

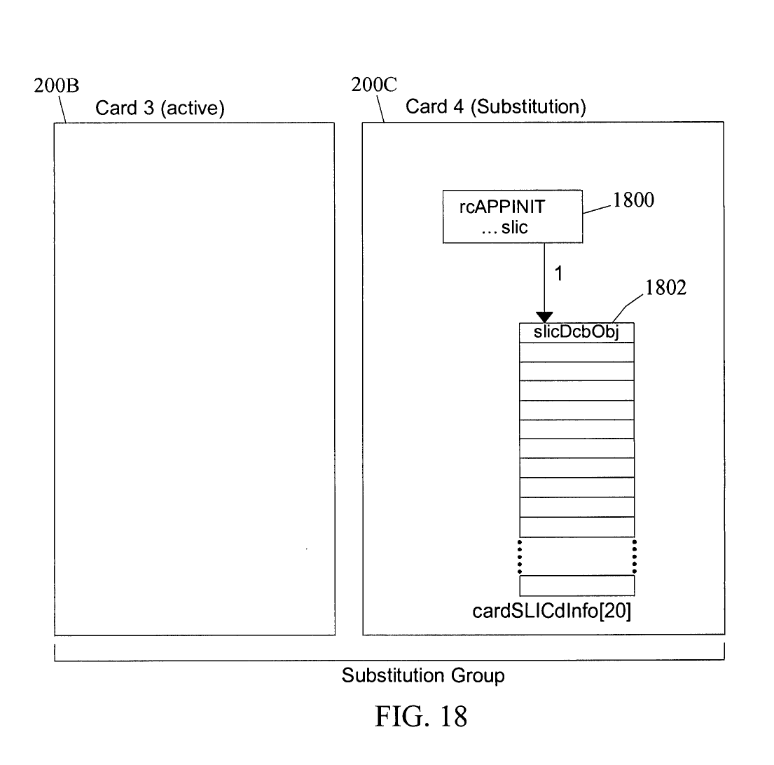

FIG. 18 illustrates exemplary steps performed by SLIC software at the T−2 phase of an exemplary card substitution process. The steps below correspond to the numbered arrows in FIG. 18.

Step 1:

In step 1, a SLIC device and a SLIC process (slicd) are created and started by a startup script rcAPPINIT 1800 when it invokes “slic”. The SLIC device is a software instantiation of the SLIC hardware. The SLIC process is a message handler used for sending messages to and from the SLIC device. In one exemplary implementation, each LTC card includes 32 SLIC chips, which are controlled by the SLIC device. Each SLIC chip may terminate one twisted pair subscriber line. The only functionality that needs to be performed for card substitution support at this step is to check if the card is a substitution card (using a call to rear_read( )). If the card is a substitution card, an array 1802 of SLIC substitution objects (slicDcbObj) will be created. Even without configuration information, the LTC card knows whether it is a substitution card or not. A substitution card has different hardware that can be detected.

Array 1802 is called the cardSLICdInfo [symbol] and is 20 elements (one for each card slot) in length. Each array element will be an ISE object (slicDcbObj) that contains four 32-bit unsigned integers. They are: int prevstat, int online, int groundstart, int client. The prevstat field is 32-bits wide and has the onhook/offhook information for each of the 32 SLICs (0=onhook, 1=offhook).

The online field is 32-bits wide and has the online status of each of the 32 SLICs. If the bit is a “one”, then the SLIC is actively provisioned, otherwise the SLIC is not provisioned. The groundstart field is 32-bits wide and each bit will indicate whether its corresponding SLIC is configured as groundstart or not (1=groundstart, 0=loopstart). The client field contains the process ID of the client that uses the SLIC daemon. This is usually the application process (pid 3f). Each array element is initialized to zero until the service cards send an update. No actions are performed on the service cards.

T−1 and Holding Phase

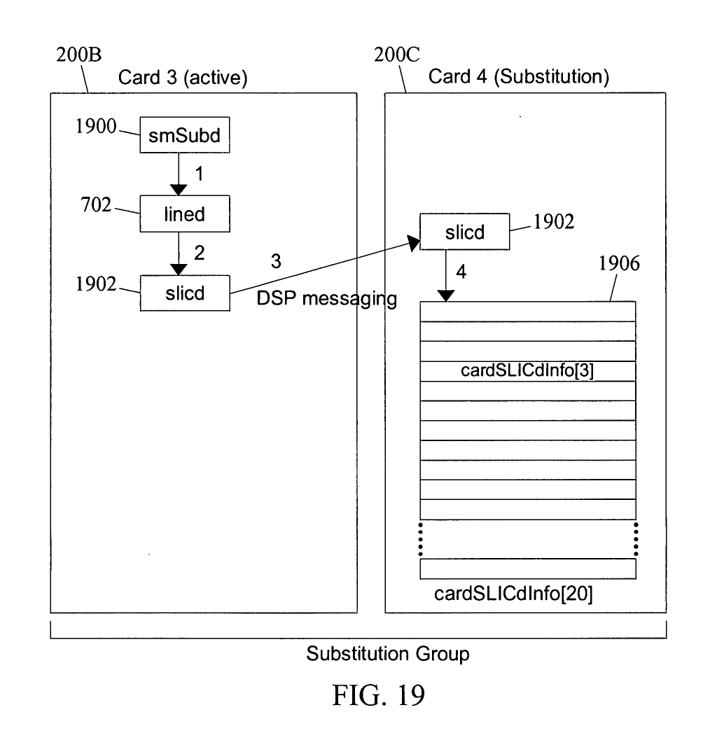

The T−1 and Holding phase of any active card may commence once the copy of the tmsSubstCardInfo event has been sent to the substitution card. The fact that the active card receives the tmsSubstCardInfo event implies that the substitution card is ready. The lined process on the active card will provide this information to the slicd process so that the SLIC can be ready for a substitution event. FIG. 19 illustrates exemplary steps that may be performed by the SLIC software in the T−1 and holding phase. The steps described below correspond to the numbered arrows in FIG. 19.

Step 1:

In step 1, smSubd process 1900 forwards the status to lined process 702 using the tSmSubStatus message.

Step 2:

In step 2, when the tSmSubStatus message is sent, it indicates to lined process 702 that the status is READY, and lined process 702 will check if the current card type is an LTC. If the card is an LTC, lined process 702 will send a SLICd_SubCard message to slicd process 1902. The SLICd_SubCard message informs slicd process 1902 which card is its substitution card. In the example in FIG. 19, slicd process 1902 would be told that its substitution card is in slot 4.

The SLICd_SubCard message also serves as a trigger to let slicd process 1902 know that whenever there is a change to any SLIC's status, it needs to forward that SLIC status information to its substitution card via the inter-card DSP messaging system.

Step 3:

Now that slicd process 1902 knows who its substitution card is, it will send any SLIC status changes to slicd process 1902 of its substitution card via the inter-card DSP messaging system. A SLIC status change will be any transition between onhook and offhook, a configuration change between groundstart and loopstart, or a configuration change between online and offline. The SLIC status information is sent with a slicDcbObj message which is described in the T−2 Phase.

Step 4:

When the slicDcbObj message is received by slicd process 1902 of the substitution card, it will replace the current slicDcbObj information in cardSLICdInfo array 1906. The slot number of the card sending the slicDcbObj information will provide the index into this array. This will ensure that substitution card 200C is ready for a substitution event.

Card Failure

A card failure can occur either as a result of a software or hardware failure or due to a manual switchover that is part of a rolling substitution procedure. The substitution process may send the following message to the lined process on the substitution card to inform it which card has failed. The following function call may be used to send the message:
Send(cardVirtualPid, tSmSubSWACT, 2, fromCard, toCard);
   In the function call, the first parameter is the destination card ID. The second parameter is the message type, tSmSubSWACT. The next parameter “2” specifies the number of parameters that follow. The fromCard parameter identifies the card from which the message is being sent. The toCard parameter identifies the card to which the message is being sent.

When lined process 702 of substitution card 200C receives the tSmSubSWACT message, it will check if the card type is an LTC. If the card type is an LTC, it will send the following message to slicd process 1902 on substitution card 200C. The following function call may be used to send the message:
Send(cardVirtualPid, SLICd_SWACT, 3, fromCard, toCard, subCard);
   In the function call, the first parameter is the destination card ID. The second parameter is the message type, SLICd_SWACT. The next parameter “3” specifies the number of parameters that follow. The fromCard parameter identifies the card from which the message is being sent. The toCard parameter identifies the card to which the message is being sent. The subCard parameter identifies the substitution card of the sending LTC. These messages will be a trigger to move to the T+1 phase.
   T+1 Phase

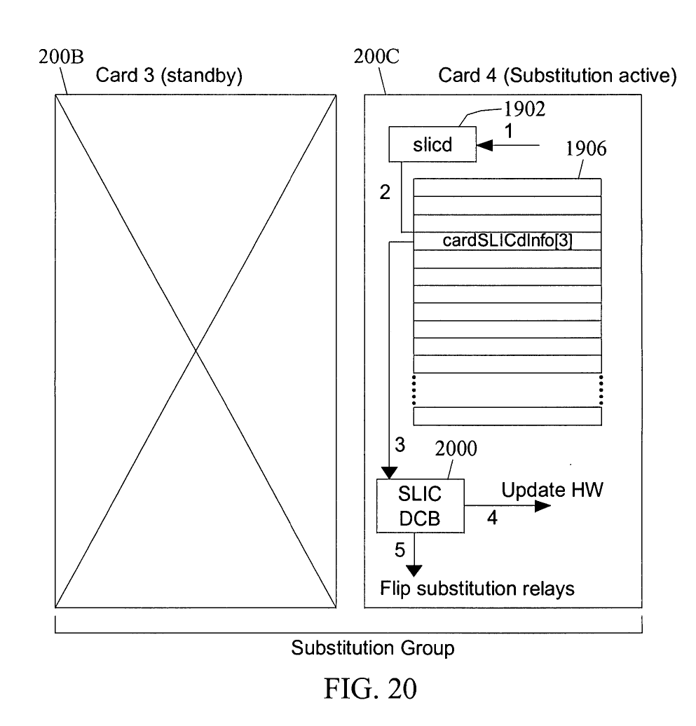

In the T+1 phase, the substitution process may detect the card failure and may be responsible for notifying the TMS as to which card has failed. The TMS lined process will provide the slicd process with notification of the substitution event with the SLICd_SWACT message as described in the previous section. It is important that all the steps in this phase occur very quickly. Although there are no alarm considerations with respect to the SLICs, there are human factors, and it is desirable to minimize the time from card failure to substitution card restoration of the call state. FIG. 20 illustrates exemplary steps that may be performed by the SLIC software in the T+1 phase. The steps described below correspond to the numbered arrows in FIG. 20.

Step 1:

Step 1 begins when slicd process 1902 of substitution card 200C receives the SLICd_SWACT message originated by lined process 702 of substitution card 200C. This message will inform substitution card 200C of the active card for which substitution is being performed. The SLICd_SWACT message has “from card” and “to card” information. The slicd process 702 of substitution card 200C may make sure that the “to card” is its own slot number.

Step 2:

In step 2, the SLICd_SWACT message “from card” is used as the index into cardSLICdInfo array 1906.

Step 3:

In step 3, the slicDcbObj information contained in cardSLICdInfo array 1906 will contain the latest SLIC state information that was received by substitution card 200C from failed card 200B. The data in the array is used to update the information in SLIC DCB (Device Control Block) 2000. SLIC DCB 2000 is used for any further SLIC activities on substitution card 2000.

Step 4:

In step 4. with the new SLIC DCB update from the slicDcbObj data in cardSLICdInfo array 1906, the SLIC hardware will be updated appropriately.

Step 5:

In step 5, once SLIC DCB 2000 is configured, and the SLIC hardware is ready to take over for the failed card, the SLIC relays will be flipped so that the POTS lines terminate on the substitution card now. The SLICs are now ready to move to the next phase for auditing.

T+2 Phase

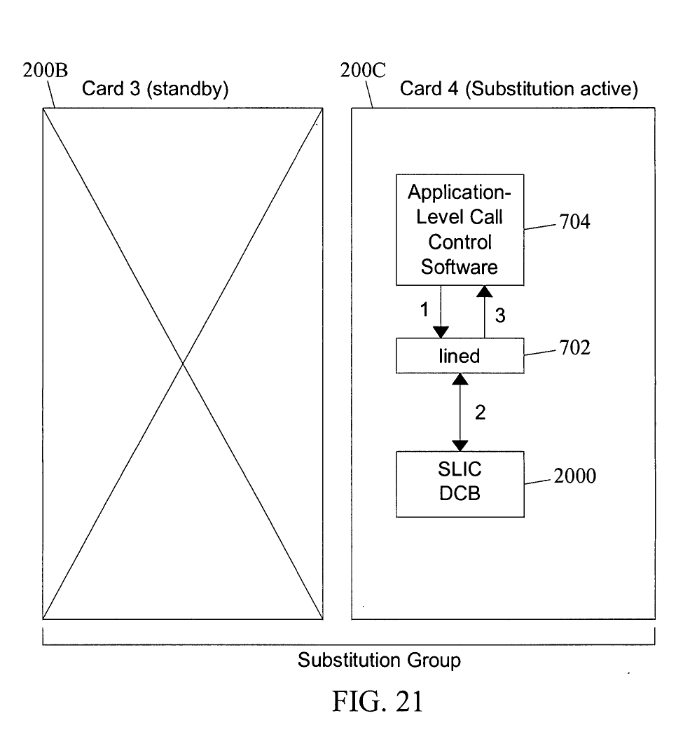

At this point, the slicd process will handle events normally. The substitution card, which is now active, is ready for any auditing needed by call processing to maintain stable analog POTS calls. FIG. 21 shown below illustrates exemplary steps that may be performed by the SLIC software during the T+2 phase. The steps described below correspond to the numbered arrows in FIG. 21.

Step 1:

In step 1, once application-level call control software 704 of substitution card 200C receives the tSmSubAuditRdy message, it will begin to audit the information from the SLIC. Application-level call control software 704 of substitution card 200C will know that the card type is an LTC and will audit all of the analog POTS lines. Application-level call control software 704 of substitution card 200C will send a t1d_querySigEvent message to lined process 702 of substitution card 200C for each POTS line (all 32 of them).

Step 2:

In step 2, lined process 702 of substitution card 200C could have sent a message to process 1902 of substitution card 200C. However, for speed considerations, lined process 702 of substitution card 200C may call a lookup function (getLastLineRxSignal) for the state of each of the analog POTS lines. The information is contained in SLIC DCB 2000 of substitution card 200C. Lined process 702 of substitution card 200C may have the audit information needed by application-level call control software 704 of substitution card 200C after it calls the lookup function.

Step 3:

In step 3, lined process 702 of substitution card 200C may respond back to application-level call control software 704 with the state of each SLIC. The data will simply contain the current receive signal state (onhook or offhook). If application-level call control software 704 has its own checkpoint data that says the POTS line is offhook, yet the SLIC indicates we are onhook, this is considered a mismatch and the call is dropped from the point of view of application-level call control software 704. This will allow future call originations on the POTS line for which the call was dropped.

Switch Back

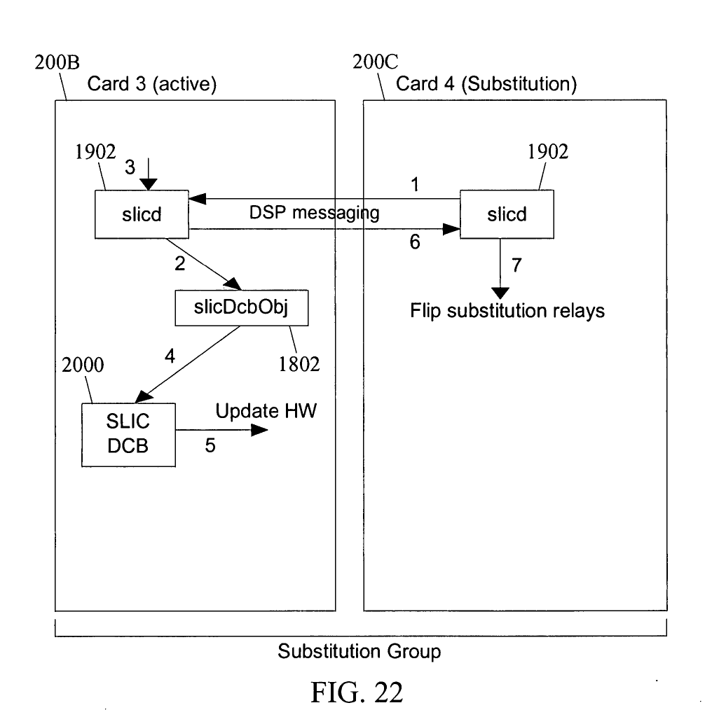

Once the failed card has been rebooted, it may be desirable to switch to the failed card as soon as possible to reduce the number of calls that must be transitioned from the substitution card to the restored card. After substitution, the failed card may eventually reboot and be in a booted/standby condition. Once it reaches this point, the active substitution card can send the SLIC status information along with any updates to the standby card. Upon receipt of the SLIC status information the standby card can be restored to an active state via the “switch back” procedure. FIG. 22 illustrates exemplary steps that may be performed by the SLIC software in performing a switch back according to an embodiment of the subject matter described herein.

Step 1:

In step 1, when standby card 200B reaches a READY state (ex: fully booted) substitution card 200C may be notified of this status by a process referred to as the system manager substitution daemon (sysmSubd) process. This process may execute on any of the cards in the system. Slicd process 1902 on substitution card 200C may send the slicDcbObj message to slicd process 1902 on standby card 200B via the inter-card DSP messaging system. Also, once this occurs, any changes in the SLIC status will be sent from active substitution card 200C to standby card 200B to ensure that standby card 200B reflects the latest SLIC state and is ready to become active again.

Step 2:

In step 2, whenever a slicd process 1902 of a standby LTC card receives a slicDcbObj message, it will save that information in a card local slicDcbObj 1802 data variable.

Step 3:

In step 3, the switchback command is entered (“swact 4 3”), and this starts that actual transition of standby card 200B to active and active substitution card 200C to a standby state. Slicd processes 1902 on all cards in the shelf will be informed that the substitution event is occurring and which cards are affected (the “from” card and the “to” card).

Step 4:

In step 4, slicd process 1902 on the “to” card will look up the slicDcbObj and copy the information into SLIC DCB object 2000 on active card 200B.

Step 5:

In step 5, the SLIC DCB information will be used to configure the SLIC hardware.

Step 6:

In step 6, once the hardware is configured, slicd process 1902 on the “to” card will send a SLICdSwitchback message to the “from” card (substitution card 200C). This will tell substitution card 200C that the “to” card is ready to resume control and become active.

Step 7:

In step 7, slicd process 1902 of substitution card 200C will flip the substitution relays so that the analog POTS lines are now physically connected to the SLICs in the “to” card 200B.

In FIG. 22, card 200B is now the active card again, and substitution card 200C is transitioned to the standby state.

The application code will treat this as another substitution event and will perform an audit of the SLIC lines just as in the T+2 Phase. Any mismatch of SLIC state will result in the call being torn down.

The substitution process will resume from the T−1 Phase and both active card 200B and substitution card 200C will be ready for any future substitution event.

Although the switchback example indicated that there is some manual intervention that starts the switchback procedure, an auto-revertive scheme can be used. This would allow an automatic switchback to a service card once it reaches a READY state after a substitution.

Even though the examples above show a single active or service card, N cards may be used with each substitution card, where N is an integer of one or more, without departing from the scope of the subject matter described herein.

V. System Manager and System Monitor Functions for Card Substitution

1 Scope

This section describes a method for accurately and rapidly detecting the failure of a card. This includes differentiating between failed/failing cards and busy cards. Methods for manual and automatic substitution will be described. Also, methods for manual and automatic switchback will be described.

As stated above, a system for substitution of card-based telephony switch module substitution may include a system manager process that executes on a card that performs shelf-level management functions. For example, the system manager is still responsible for deterministic boot-up and operation of each card in the shelf and orchestrating the relationship between cards in the shelf. The system manager process may include a substitution process, referred to as the system manager substitution daemon (smsubd) to control substitution functions, such as establishing substitution groups. A system monitor function (sysMon) may monitor card status and communicate that status to the system manager substitution daemon.

The system monitor may be responsible for monitoring the “health” of each card in the shelf and declaring card insanity notifications (H/W or SAN faults).

The smsubd may depend on the system monitor and system manager (census/status) to determine card replacement when a failed card is identified. The smsubd may implement substitution commands, such as switchover and switchback commands).

2 Overview

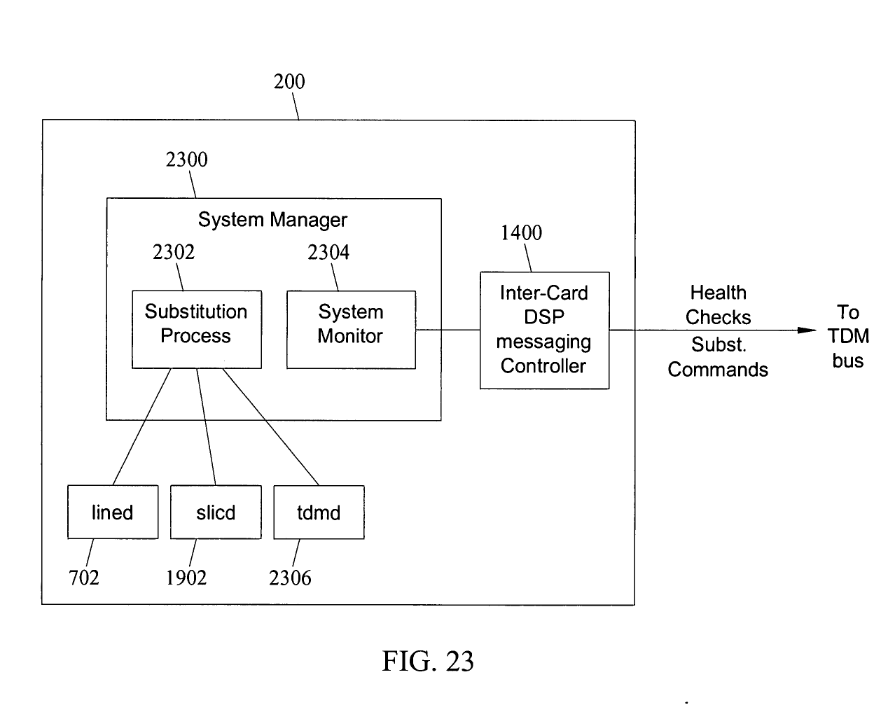

As stated above, to support card substitution, a system monitor (sysMon) and a system manager substitution (smsubd) capability may be implemented as part of the system manager module. FIG. 23 illustrates an example of a card 200 with a system manager module 2300. In FIG. 23, system manager module 2300 includes substitution process 2302 and system monitor 2304. System monitor 2304 may collect system status information for card. 200. Substitution process 2302 may maintain overall card status within a substitution group in order to initiate and control a substitution switchover and switch back.

A system monitor 2304 may run on each card to collect status information for each card. Commands may be available to monitor data that a system monitor 2304 has accumulated. System monitor status updates may be sent by cards in a substitution group to the substitution card for the group via the inter-card DSP messaging system 1400.

All cards may contain a system manager substitution process 2302, also referred to as smsubd, to support substitution. Substitution process 2302 may receive an application's message to determine substitution configuration. Substitution process 2302 may send messages to lined 702, slicd 1902, TDM daemon (tdmd) 2306 and inter-card DSP messaging 1400 processes indicating substitution group membership. When inter-card DSP messaging process 1400 starts, it may open a Tx channel on each card. Applications may indicate when the database is loaded on a card. When member card data base is loaded and subCard ready (@ run level 8), messages may be sent to lined 702, slicd 1902, and tdmd 2306 to begin their duplicating of information to support card substitution. Afterward, system monitor 2304, lined 702, slicd 1902 and tdmd 2306 processes may transmit their status, signaling and connection information changes only. The data is not being sent to any particular card. Rather, it may be sent to a process identifier corresponding to substitution process 2302, and substitution process 2302 may be registered to listen for messages having its process identifier.

Substitution process 2302 may inform inter-card DSP messaging process 1400 of its substitution group status. Inter-card DSP messaging process 1400 may open receive ports based upon the substitution configuration. Inter-card DSP messaging process 1400 may be responsible for enabling the inter-card DSP message receive process on the substitution card within the substitution group. The substitution card may have receive ports open from each card in the substitution group. In addition, inter-card DSP messaging receive process on a substituted out card may be enabled to support possible automatic switchback.

Substitution process 2302 may continually monitor messages from applications indicating substitution configuration. If the substitution card configuration changes, substitution process 2302 may send the new substitution membership/status to all cards within the substitution group.

With the inter-card DSP message receive process turned on for a card (which by definition may be a substitution card and/or possibly a substituted out card), substitution process 2302 is able to collect the system monitor data from all cards in the substitution group. The substitution process 2302 on the substitution card may process information from system monitor 2304 and make a determination as to card health for each card in the substitution group. If the health of a card reaches a certain threshold and the substitution card is currently not already substituting for another card, a switchover may be automatically initiated. In order to initiate an automatic switchover, a message may be broadcast over the message bus telling processes to perform their substitute function. Relays may be commanded by lined process 702 on the substitution card. The failed card may be disabled by sending a disable message to the failed card via the inter-card DSP messaging system or the message bus. Once the failed card is disabled, substitution process 2302 may update its internal substitution status and send a message to the cards in the substitution group containing the new configuration. The inter-card DSP message receive process may remain enabled on the substitution card by the inter-card DSP messaging process 1400 to support future switchovers (from other cards). On substitution, auditing information must be coordinated between system manager 2300 and applications. Non-substitution communication may utilize standard inter-process communication (IPC) messaging via the message bus.

When the substituted card comes back up, it may become available for switchback. This card may be the only card available for switchback. When substitution process 2302 initializes and determines its substitution status on this card, it may send a message containing the configuration and status of the card. Inter-card DSP messaging process 1400 may enable the inter-card DSP receive process on the substituted out card for processes to duplicate signaling/status in a manner similar to pre-switchover. A message may be sent to the substitution card to indicate the member is back up. At this point, configuration information may be relayed back to the member card to allow card substitution on the switchback.

3 System Monitor Functions

3.1 Initialization/Startup

When the system monitor 2304 on each card is started, a periodic timer may be set up to collect system monitor status information (Data Collection). The data is sent to the inter-card DSP message transmit interface

3.2 Data Collection

On a periodic basis, following system information may be monitored:

| Level | Scope | Monitored Data | Period |
|---|---|---|---|
| Card | all | Memory Usage | configurable |
| Card | all | idle CPU time | configurable |
| Process | subset | process existence | configurable |
| | | (verify certain processes exist and | |
| | | running) | |
| Process | 3f | memory, cpu | configurable |
| Card | all | SysMgr card state | |
| Card | all | Device Failure (mchdlc, mchdlc, dsp) | |
| Card | all | Bus Failure (msgBus - frames | |
| | | not passing, | |
| | | bridge/pump, DSP) | |
| Card | all | PegCounts (interrupt queue, | |
| | | signalTimer, Tx queue, other) | |
| Card | all | Event Manager Information | |

The state of the card on which system manager 2300 is executing and inter-card DSP messaging status (TDM/DSP) may be monitored by substitution process 2302.

Each card may store its system monitoring information locally. A history of information may be maintained for trend/time analysis. Each card may communicate its status to substitution manager 2302 over the inter-card DSP messaging system. Examples of card status that may be computed by each card and sent over the inter-card DSP messaging status to substitution process 2302 include: CARD_PASSED, CARD_FAILING , CARD_FAILED, CARD_UNKNOWNSTATUS.

3.3 Tx Inter-Card DSP Messaging Interface

The system monitor data collected may be packaged into a message (less than 128 bytes) and sent to the subWayPid. Inter-card DSP messaging process 1400 may be responsible for message redundancy and DSPFTDM bus connection and communication.

The message that carries the status information may be of the type tSmSubMon. The following function call may be used to generate and send such a message:
Send (subWayPid, tSmSubMon, 2, cardNum, cardStatus);
   In the function call, subWayPid is the process ID of the inter-card DSP messaging controller on the substitution card. tSmSubMon is the message type. “2” is the number of parameters that follow. cardNum is the number of the card sending the message. cardStatus is the status of the card sending the message.
   4 Substitution Process Functions
   4.1 Initialization/Startup

Substitution process 2302 may be a separate process as part of system manager process 2300 to allow for substitution message priority and handling during critical periods.

System manager 2300 may be knowledgeable about all shelf related configuration. To support card substitution, the following system biographical information may be updated by system manager 2300:

1. tBio (card level)—identifies card level

2. tGSubConfig—subgroups in shelf
tGSubConfig—global sub config
   [1] tSubConfig
      subCard
      priority
      subStatus
      aswConfDone
      auditRdy
   where subStatus=ACTIVE, STANDBY, UNAVAILABLE

This information is obtained in configuration messages from applications: tSmSubConfig and tSmSubAswConfDone and platform processes, as well as determined internally.

Substitution process 2302 on each card registers for an application's message containing subgroup membership. A check is made to determine if the configuration is valid based upon biographical information. tSmsub_Config_Response is returned to the sending process with configuration validity indications.

This information is forwarded to the active system manager 2300, which stores the substitution configuration for the entire shelf as a system biography. If valid, the substitution configuration is further disseminated to the low level drivers supporting card substitution: lined, tdmd, slicd, inter-card DSP messaging process to enable their pre-substitution preparation processing (signaling replication). A tSmsub_Status message is sent to each card.

Membership is the substitution group and card status may determine subsequent processing. The Substitution Membership/Status may be verified on an on-going basis. The substitution status message may be processed, regardless of membership. This may allow for any card to detect the change and updates its card substitution role. It is assumed that applications may asynchronously send a message whenever substitution group status changes.

After a card boots and the database configuration is loaded, a tSmSubAswConfDone message may be sent on each card to substitution process 2302. The current state (runlevel) of the card may be used as a check to ensure message content integrity. A response may be sent back indicating validity. Substitution process 2302 may relay this information to the active system manager 2300 to store in the system biographical information. When a member card in a subgroup has completed its configuration and its substitution card is at run level 8, a tSmSubAswConfDone message may be sent to the low level drivers for card substitution preparation.

Once the inter-card DSP messaging receivers are opened by the inter-card DSP messaging process, the system monitor and inter-card DSP messaging status messages can be received by substitution process 2302 on the substitution card. It is the receipt of these messages that may trigger subsequent data analysis and possible substitution initiation (substitution monitor data collection, health determination and possible substitution initiation).

4.2 Substitution Membership/Status

Before the lined and tdmd processes begin replicating signaling and connections, the application's database must have completed loading. An additional message may be sent by applications after the database configuration is completed on each card. Substitution process 2302 may send each card in its subgroup a software configuration complete message after it and its subCard (@ run level 8) are complete, i.e. source and destination of information is ready. If a subsequent software config message is sent, low level drivers may reconfig as required.

Processing performed by substitution process 2302 on each card may be based upon the substitution membership and status. The following rules illustrate exemplary processing that may be performed by substitution process 2302 on each card:

1. Card is the subcard in the subgroup, not active (i.e. not in substitution)
a. Tx enabled; Rx Inter-card Messaging Processes from all cards in subgroup enabled by the inter-card DSP messaging process.
   i. SysMon messages are received and processed.
   ii. The inter-card DSP messaging process status messages are received and processed.
b. On swConfigDone, low level drivers begin their card processing.
   i. Low level drivers do large configuration setup
c. Substitution process 2302 may monitor the substitution configuration and data base configuration messages from apps in case card's subgroup configuration changes

2. Card is the subcard in the subgroup, active (i.e. in substitution)
a. Tx enabled; Rx Inter-card DSP messaging processes from all cards in subgroup enabled by the inter-card DSP messaging process.
   i. SysMon messages are received and processed.
   ii. Inter-card DSP messaging process status messages are received and processed.
b. Switchback not allowed until sub'd out card is back up and ready (rI 8)
c. Substitution process 2302 may monitor the substitution configuration and data base configuration messages from apps in case card's subgroup configuration changes

3. Card is subgroup member, active (i.e. not in substitution)
a. Tx enabled; The Rx inter-card DSP communication process is not enabled so there is no subsequent processing based upon any input inter-card DSP messages.
b. Substitution process 2302 may monitor the substitution configuration and database configuration messages from apps in case card's subgroup configuration changes.

4. Card is subgroup member, not active, not ready (i.e. sub'd out, not yet available for switchback)
a. Tx enabled; Rx inter-card DSP communications processes are not enabled so there is no subsequent processing based upon any input inter-card DSP communication messages.
b. Substitution process 2302 may monitor the substitution configuration and data base configuration messages from apps in case card's subgroup configuration changes.
c. Configuration and internal card status is monitored to determine when board completely booted and is ready for switchback.

5. Card is subgroup member, not active, ready (i.e. sub'd out, ready for switch back)
a. Tx enabled; Rx inter-card DSP messaging processes from subCard enabled by the inter-card DSP messaging process.
   i. SysMon messages are received and processed
   ii. Inter-card DSP messaging process status messages are received and processed
   iii. Low level drivers receive updates
   iv. If sub'd out card is ready, possible switchback is allowed.
b. Substitution process 2302 may monitor the substitution configuration and data base configuration messages from apps in case card's subgroup configuration changes

6. Card is not member of any subgroup.
a. Tx enabled; Rx inter-card DSP messaging process not enabled so there is no subsequent processing based upon any input inter-card DSP messages.
b. Substitution process 2302 may monitor the substitution configuration and data base configuration messages from apps in case card's subgroup configuration changes.
   If a substitution is initiated by the smsubd, it may update its internal status ASAP and send this information to lined, tdmd, slicd, inter-card DSP messaging process, and applications. A subsequent applications message may be expected to confirm this change after the fact.
   4.3 Rx Inter-Card DSP Messaging Interface

The inter-card DSP messaging process on the substitution card sends received messages to the cardVirtualPid.

Substitution process 2302 on the substitution card must be registered to receive the system monitor messages from all cards in the shelf. In addition, an inter-card DSP messaging status message may be registered for.

4.4 Substitution Monitor Data Collection

Raw data in messages are received from the TDM and message bus. The data in the system monitor, inter-card DSP messaging status and card status messages may be extracted and substitution information for each card may be updated in a local database.

An additional flag may be set if no messages are received from a card in the sub group within a configurable time period.

4.5 Card Health Determination

A substitution database containing inter-card DSP messaging health, card health and status/census information for each card may be stored on card 200 and analyzed. Results of this analysis may be an integrity grading of each card. The database and/or the integrity grade may be updated each time a message is received. Final determination of a Passed or Failed card state may be provided based on the analysis.

4.6 Substitution Initiation

If substitution process 2302 has determined that a card in a subgroup has failed, system manager 2300 may use its substitution membership and card status to determine if a substitution (switchover or switchback) may be commanded. The subcard is the only card that can command the relays and therefore is the only card from which a substitution can be initiated. Substitution can also be commanded, manually, via the OM and CLI. The following are exemplary rules that may be implemented by substitution process 2302 to determine whether to initiate substitution:

1. Failed card is the subcard in the subgroup, not active (i.e. not in substitution)
a. No substitution initiated. Subcard cannot substitute for itself.
b. Subcard may be disabled.
c. After card boots, substitution config messages from apps and relayed by the sysMgr to other processes may establish the substitution setup similar to shelf power-on.
d. Config done message may be sent to member cards after subCard comes back up to initiate transfer of signaling/connection information.

2. Failed card is the subcard in the subgroup, active (i.e. in substitution)
a. At this time, there may be no attempt at an automatic switchback in case.
b. Card is disabled. Calls may be dropped.
c. Only until subcard is back up and ready can a manual switchback to the sub'd out card be possible. A substitution command may be issued by sysMgr, along with substitution status update. Config Done and Audit Rdy messages are expected.

3. Failed card is subgroup member, active (i.e. not in substitution)
a. If subcard is not active (not already substituting for another card) and Ready
   i. Set Card Failed
   ii. Send substitution command message to processes on subcard.
   iii. Update internal substitution status information. Send substitution status message to affected cards.
   iv. Assassinate failed card.
   v. After failed card reboots and is Ready, it may not be candidate for automatic switchback. This may be a manual command. Sub Status messages may be sent. Config done and Audit ready messages are expected.
b. Else subcard is active (already in substitution for another card)
   i. Set card failed.
   ii. Disable failed card. No substitution possible. Calls may be dropped.
   iii. After booting, substitution status messages are sent. A substitution command is issued. Audity Rdy and Config Done messages are expected.
c. Else subcard is not Ready
   i. Substitution process 2302 may monitor subcard and failed card status and make a decision based upon who becomes ready first.
      1. If subcard comes out of failed state for some defined time period, it may perform substitution per step 3a.
      2. If the failed card becomes Ready, it may cancel potential substitution.

4. Failed card is subgroup member, not active, not ready (i.e. sub'd out, still failed/rebooting-not yet available for switchback)
a. No substitution initiated. Card is already substituted out.
b. If card is not ready after some defined time period, set card failed and re-disable the card.

5. Failed card is subgroup member, not active, ready (i.e. sub'd out, ready for switchback)
a. No substitution initiated. Card is already substituted out.
b. Disable card.
c. Any pre-substitution processing may be established when it comes back up.

6. Failed card is not member of any subgroup.
a. Disable card. No other action.
   On substitution: low level drivers send auditRdy messages to sysMgr. SysMgr may send the tSmSubAuditRdy to applications only when all drivers are ready.
   4.7 Messages
   4.7.1 External Message Interface

FIG. 24 illustrates exemplary messages that may be used between cards. In FIG. 24, the vertical lines indicate the processes between which each message type is being sent.

The following pseudo code illustrates system biographical information that may be updated per card and shelf:
/include/sys.h
(Event) tBIO (slot, type, EPROM, rEPROM, romInv, swInv, patchInv, \ daughtercard, runlevel, updated, subInv)
/include/sysmgr.h
(Event) tOCXShelfData (shelfAddr, smDealAddr, smBroadcastAddr, \ shelfInventory, debounceMap, smCardMask, \ cardStatuses, cardBIOs, cardResponses, \ cardResources, subStatus)
(Event) tSmSubConfig (cardNum, subCard, Priority)
   Command to indicate substitution configuration from applications
   Send on applications startup and on change.
   subCard=0 indicates “Not in subgroup”
   Priority=support future use
(Event) tSmSubStatusQuery (returnRoute, cardNum)
   Request for tSMSubStatus message.
   returnRoute is apps FSM route (if known) to be used in tSmSubStatus, (default value for apps to determine)
(Event) tSmSubConfig_Response (returnRoute, cardNum, subCard, priority, errorCode, errorString)
   Response sent to returnRoute to indicate validity of substitution configuration sent
(Event) tSmSubStatus(returnRoute, tGsubConfig)
   Global substitution config.
   Access card data via ptr=Get(msg→word[1], cardNum)
      tGSubConfig—global sub config
         [1] tSubConfig
            subCard
            priority
            subStatus
            aswConfDone
            auditRdy
         where subStatus=ACTIVE, STANDBY, UNAVAILABLE
      Sent to platform processes on change.
      Sent to apps on query only. Can send on change if needed.
(Event) tSMSubAswConfDone
   Command from Apps to indicate database configuration complete on current card.
   Same message type is used to by sysMgr to platform drivers when the config on a card is complete and the subCard is at the required run level allowing communication dcb information between the two, i.e. subCard must be up to receive the information from the card.
(Event) tSmSubSWACT (returnRoute, fromCard, toCard)
   Command to initiate substitution for switchover and switchback.
   Sent by applications for manual switchover & switchback.
   Sent by sysMgr to lined, slicd, tdmd, inter-card DSP messaging process, applications on substitution card to actually perform card substitution (manually initiated or based upon internal card failure).
(Event) tSmSubSWACT_Reponse (returnRoute, fromcard, tocard, errorCode, errorString)
   Response sent back to apps for SWACT invalidity.
(Event) tSmSubAuditRdy (returnRoute, cardNum)
   Command to apps when all low level drivers ready for audit.
      Notes:
1. returnRoute default value to allow for applications to determine w/o platform
2. Card failure indication may be available in current tSysStatus et al messages. Any issues with status stability of fields may be addressed.
3. Determine processing for case when cards in subgroup go down while subCard in substitution with multiple member card failures.
   4.7.2 Internal Messages

The following message may be used between processes on a card.

(Event) tSmSubMon
Contains the system monitoring information for a card (Card Status Result only).
Send from sysMon to smsubd via inter-card DSP messaging system.

(Event) tSmSubMonRequest
Interface to query for tSmSubMon message by smsubd.
Used only for test purposes.

(Event) tSmSybMonTimeout
Internal periodic, timeout period configurable

(Event) tSubMgrFailCard (slot#)
a. In case done we want to declare a card down from somewhere else.

(Event) INTER_CARD_DSP_MSG_LINK_FAILED (card)
Indicates communication to the indicated card is totally down for all TDM bus and DSPs used.

(Event) TDMd_AudityRdy

(Event) tms_AuditRdy
Internal low level driver indicators of audit ready status.
   5 CLI Commands

The following command line interface commands may be implemented:

1. querySmSubMonData <slot#> <history depth>
a. Displays the system monitoring information sent by sysMon for the current card. Data history may be available for display

2. querySmSubStatus
a. Displays the subMgr substitution state and status for the current card.

3. test_SmSubMonDataUpdate
a. Updates system monitor information. Used for testing purposes

4. test_disableSmSubMonUpdate/test_enableSmSubMonUpdate
a. Disables/Enables normal system monitoring updating for test purposes. This may allow data input via sysMonDataUpdate to be processed.

5. test_SmSubAppsConfigUpdate
a. Updates substitution configuration to simulate applications. Use for testing purposes.

6. test_SmSubCardStatusUpdate
a. Updates card status information to simulate sysMgr card status. Used for testing purposes.

7. test_SmSubCardFail <slot#>
a. Forces a card into a failed state in the subMgr. Used for testing purposes.

8. test_SmSubDataUpdate
a. Updates subMgr data. Used for testing purposes.

9. test_SmSubSubstitute <fromcard> <tocard>
a. Initiates a substitution by the subMgr. Used for testing purposes.

10. test_SmSubAswConfDone <slot#>
a. simulates application message

11. test_SmSubAuditRdy <slot#>
a. simulates audit Rdy condition

QueryBIO can be used to verify sub status BIO information as well.

It will be understood that various details of the invention may be changed without departing from the scope of the invention. Furthermore, the foregoing description is for the purpose of illustration only, and not for the purpose of limitation.

What is claimed is:

1. A method for substitution of card-based telephony bearer channel switch modules in a manner that preserves stable calls, the method comprising:
(a) designating a first card-based telephony bearer channel switch module of a plurality of card-based telephony bearer channel switch modules as a substitution switch module;
(b) designating a second card-based telephony bearer channel switch module of the plurality of card-based telephony bearer channel switch modules as an active switch module;
(c) establishing stable calls using the second card-based telephony bearer-channel switch module;
(d) at the first card-based telephony bearer channel switch module, obtaining configuration information for the second card-based telephony bearer channel switch module;
(e) at the first card-based telephony bearer channel switch module, obtaining call state information for stable calls established using the second card-based telephony bearer channel switch module; and
(f) detecting failure of the second card-based telephony bearer channel switch module, and, in response, switching, using the configuration and call state information, the first card-based telephony bearer-channel switch module to operate as the second card-based telephony bearer channel switch module in a manner that maintains the stable calls.

2. The method of claim 1 wherein designating a first card-based telephony bearer channel switch module as a substitution switch module includes configuring the first card-based telephony bearer channel switch module as substitution switch module for n active switch modules, n being an integer of at least 1.

3. The method of claim 1 wherein obtaining configuration information for the second card-based telephony bearer channel switch module includes sending the configuration information from the second card-based telephony bearer channel switch module to the first card-based telephony bearer channel switch module.

4. The method of claim 1 the configuration information includes bearer channel framing information.

5. The method of claim 1 wherein obtaining call state information includes sending call state update messages from the second card-based telephony bearer channel switch module to the first card-based telephony bearer channel switch module over a message bus connecting the first and second card-based telephony bearer channel switch modules.

6. The method of claim 1 wherein obtaining call state information includes sending call state update messages from the second card-based telephony bearer channel switch module to the first card-based telephony bearer channel switch module over a time division multiplexed (TDM) bus connecting the first and second card-based telephony bearer channel switch modules.

7. The method of claim 6 comprising using the TDM bus for bearer channels corresponding to the stable calls.

8. The method of claim 7 wherein sending the messages over the TDM bus includes sending the messages from a digital signal processor (DSP) associated with the second card-based telephony bearer channel switch module.

9. The method of claim 1 wherein switching the first card-based telephony bearer channel switch module to operate as the second card-based bearer channel switch module in a manner that maintains the stable calls includes using same time division multiplexed (TDM) timeslots used for the stable calls prior to failure of the second card-based telephony bearer channel switch module.

10. The method of claim 9 comprising testing the TDM timeslots used to maintain the stable calls.

11. The method of claim 1 wherein switching the first card-based telephony bearer channel switch module to operate as the second card-based bearer channel switch module in a manner that maintains the stable calls includes renegotiating time division multiplexed (TDM) timeslots used for the stable calls.

12. The method of claim 1 comprising, detecting re-activation of the second card-based telephony bearer channel switch module, and, in response, switching the roles of the first and second card-based telephony bearer channel switch modules in a manner that preserves stable calls maintained by the first card-based telephony bearer channel switch module.

13. A system for substitution of card-based telephony channel switch modules in a manner that preserves stable calls, the system comprising:
(a) a first card-based telephony bearer channel switch module for operating as substitution switch module; and
(b) a second card-based telephony bearer channel switch module for operating as an active switch module, wherein the first card-based telephony bearer channel switch module is adapted to obtain configuration and call state information for stable calls maintained by the second card-based telephony bearer channel switch module for calls involving the second card-based telephony bearer channel switch module and wherein, in response to failure of the second card-based telephony bearer channel module, the first card-based telephony bearer channel switch module is adapted to switch, using the configuration information and the call state information, to operate as the second card-based telephony bearer channel switch module in a manner that preserves the stable calls.

14. The system of claim 13 wherein the first card-based telephony bearer channel switch module is adapted to function as a substitution switch module for n active switch modules, n being an integer of at least 1.

15. The system of claim 13 wherein the second card-based telephony bearer channel switch module is adapted to send the configuration information to the first card-based telephony bearer channel switch module.

16. The system of claim 13 wherein the configuration information includes bearer channel framing information.

17. The system of claim 13 wherein the second card-based telephony bearer channel switch module is adapted to send call state update messages to the first telephony bearer-channel switch module using a message bus interconnecting the first and second card-based telephony bearer channel switch modules.

18. The system of claim 13 wherein the second card-based telephony bearer channel switch module is adapted to send call state update messages to the substitution switch module using a time division multiplexed (TDM) bus interconnecting the first and second card-based telephony bearer channel switch modules and used to carry bearer channel traffic between the first and second card-based telephony bearer channel switch modules.

19. The system of claim 18 wherein the second card-based telephony bearer channel switch module includes a digital signal processor (DSP) and wherein the DSP is adapted to send the call state update messages to the first card-based telephony bearer channel switch module over the TDM bus.

20. The system of claim 13 wherein, in response to failure of the second card-based telephony bearer channel switch module, the first card-based telephony bearer channel switch module is adapted to maintain the stable calls using the same time division multiplexed (TDM) timeslots used for the stable calls prior to failure of the second card-based telephony bearer-channel switch module.

21. The system of claim 13 wherein, in response to failure of the second telephony bearer channel switch module, the first card-based telephony bearer channel switch module is adapted to renegotiate time division multiplexed (TDM) timeslots used for stable calls maintained by the second card-based telephony bearer-channel switch module.

22. A system for substitution of card-based bearer channel switch modules, the system comprising:
(a) an active card-based telephony bearer channel switch module for performing switching operations for telephone calls; and
(b) a substitution card-based telephony bearer channel switch module for obtaining configuration and state information from the active telephony bearer channel switch module, and, in response to failure of the active telephony bearer channel switch module, for switching to operate as the active telephony bearer channel switch module in a manner that preserves stable calls maintained by the active card-based telephony bearer channel switch module.

23. The system of claim 22 wherein the active card-based telephony bearer channel switch module is adapted to terminate at least one DS-n trunk, where n is an integer of at least 0.

24. The system of claim 22 wherein the active card-based telephony bearer channel switch module is adapted to terminate at least one analog telephone subscriber line.

25. The system of claim 22 comprising a time-division-multiplexed (TDM) bus interconnecting the active and substitution card-based telephony bearer channel switch modules for carrying bearer channel traffic regarding calls involving the active card-based telephony bearer channel switch module.

26. The system of claim 25 comprising first and second digital signal processors (DSPs) and first and second TDM drivers respectively associated with the active and substitution card-based telephony bearer channel switch modules, wherein the first and second DSPs are adapted to exchange messages relating to card substitution via at least one TDM channel on the TDM bus.

27. A computer program product comprising computer-executable instructions embodied in a computer-readable medium for performing steps comprising:
(a) designating a first card-based telephony bearer channel switch module of a plurality of card-based telephony bearer channel switch modules as a substitution switch module;
(b) designating a second card-based telephony bearer channel switch module of the plurality of card-based telephony bearer channel switch modules as an active switch module;
(c) establishing stable calls using the second card-based telephony bearer-channel switch module;
(d) at the first card-based telephony bearer channel switch module, obtaining configuration information for the second card-based telephony bearer channel switch module;
(e) at the first card-based telephony bearer channel switch module, obtaining call state information for stable calls established using the second card-based telephony bearer channel switch module; and
(f) detecting failure of the second card-based telephony bearer channel switch module, and, in response, switching, using the configuration and call state information, the first card-based telephony bearer-channel switch module to operate as the second card-based telephony bearer channel switch module in a manner that maintains the stable calls.

28. The computer program product of claim 27 wherein designating a first card-based telephony bearer channel switch module as a substitution switch module includes configuring the first card-based telephony bearer channel switch module as substitution switch module for n active switch modules, n being an integer of at least 1.

29. The computer program product of claim 27 wherein obtaining configuration information for the second card-based telephony bearer channel switch module includes sending the configuration information from the second card-based telephony bearer channel switch module to the first card-based telephony bearer channel switch module.

30. The computer program product of claim 27 the configuration information includes bearer channel framing information.

31. The computer program product of claim 27 wherein obtaining call state information includes sending call state update messages from the second card-based telephony bearer channel switch module to the first card-based telephony bearer channel switch module over a message bus connecting the first and second card-based telephony bearer channel switch modules.

32. The computer program product of claim 27 wherein obtaining call state information includes sending call state update messages from the second card-based telephony bearer channel switch module to the first card-based telephony bearer channel switch module over a time division multiplexed (TDM) bus connecting the first and second card-based telephony bearer channel switch modules.

33. The computer program product of claim 32 comprising using the TDM bus for bearer channels corresponding to the stable calls.

34. The computer program product of claim 33 wherein sending the messages over the TDM bus includes sending the messages from a digital signal processor (DSP) associated with the second card-based telephony bearer channel switch module.

35. The computer program product of claim 27 wherein switching the first card-based telephony bearer channel switch module to operate as the second card-based bearer channel switch module in a manner that maintains the stable calls includes using same time division multiplexed (TDM) timeslots used for the stable calls prior to failure of the second card-based telephony bearer channel switch module.

36. The computer program product of claim 35 comprising testing the TDM timeslots used to maintain the stable calls.

37. The computer program product of claim 27 wherein switching the first card-based telephony bearer channel switch module to operate as the second card-based bearer channel switch module in a manner that maintains the stable calls includes renegotiating time division multiplexed (TDM) timeslots used for the stable calls.

38. The computer program product of claim 27 comprising, detecting re-activation of the second card-based telephony bearer channel switch module, and, in response, switching the roles of the first and second card-based telephony bearer channel switch modules in a manner that preserves stable calls maintained by the first card-based telephony bearer channel switch module.
